(19) United States
(12) Patent Application Publication
(10) Pub. No.: US 2026/0353027 A1
(43) Pub. Date: Nov. 5, 2026

(54) SOUND WAVE REVERBERATION METHOD

(71) Applicant: TENCENT TECHNOLOGY (SHENZHEN) COMPANY LIMITED, Shenzhen (CN)

(72) Inventor: Dong YANG, Shenzhen (CN)

(73) Assignee: TENCENT TECHNOLOGY (SHENZHEN) COMPANY LIMITED, Shenzhen (CN)

(21) Appl. No.: 19/715,821

(22) Filed: Jun. 22, 2026

Related U.S. Application Data
(63) Continuation of application No. PCT/CN2025/084317, filed on Mar. 24, 2025.

(30) Foreign Application Priority Data
Apr. 30, 2024 (CN) 202410540718.3

(51) Int. Cl. H04S 7/00

(52) U.S. Cl. CPC H04S 7/305; H04S 7/302; H04S 2400/11

(57) ABSTRACT

In a sound wave reverberation method, attenuation parameters and delay durations of a plurality of image sound sources corresponding to a sound source are obtained. An impulse response of each of the image sound sources is determined based on an impulse function and the delay duration of the respective image sound source. For each of the image sound sources, convolution is performed on a first sound wave, the attenuation parameter of the respective image sound source, and the impulse response of the respective image sound source to obtain a second sound wave corresponding to the respective image sound source, the first sound wave being a sound wave emitted by the sound source and received by a receiver. In the method, a target sound wave is generated based on superposition of the at least two obtained second sound waves.

### RELATED APPLICATIONS

The present application is a continuation of International Application No. PCT/CN2025/084317, filed on Mar. 24, 2025, which claims priority to Chinese Patent Application No. 202410540718.3, filed on Apr. 30, 2024, and entitled “SOUND WAVE REVERBERATION METHOD AND APPARATUS, COMPUTER DEVICE, AND STORAGE MEDIUM.” The entire disclosures of the prior applications are hereby incorporated by reference.

### FIELD OF THE TECHNOLOGY

Embodiments of this disclosure relate to the field of computer technologies, including a sound wave reverberation method and apparatus, a computer device, and a storage medium.

### BACKGROUND

Reverberation of a sound wave refers to a phenomenon in which, when the sound wave propagates and encounters an obstacle, the sound wave is reflected and absorbed by the obstacle, and after being reflected and absorbed for a plurality of times, portions of the sound wave still exist after a sound source stops sounding. In some scenarios, an audio digital signal processing technology may be used in a plurality of fields to form a digital reverberation effect for the sound wave, such as song production or movie dubbing.

### SUMMARY

Embodiments of this disclosure include a sound wave reverberation method and apparatus, a computer device, and a storage medium, which may improve the quality of an obtained target sound wave with a reverberation effect.

According to an aspect, a sound wave reverberation method is provided. In the method, attenuation parameters of a plurality of image sound sources corresponding to a sound source and delay durations of the image sound sources are obtained, the image sound sources being configured to simulate a sound wave that is emitted by the sound source and reaches a receiver after being reflected, the attenuation parameters indicating intensities of sound waves from the image sound sources and received by the receiver, and the delay durations being durations of travel of the sound waves from the image sound sources to the receiver. An impulse response of each of the image sound sources is determined based on an impulse function and the delay duration of the respective image sound source. For each of the image sound sources, convolution is performed on a first sound wave, the attenuation parameter of the respective image sound source, and the impulse response of the respective image sound source to obtain a second sound wave corresponding to the respective image sound source, the first sound wave being a sound wave emitted by the sound source and received by the receiver, and the second sound wave corresponding to the respective image sound source being a sound wave emitted by the respective image sound source and received by the receiver. In the method, a target sound wave is generated based on superposition of the obtained second sound waves.

According to an aspect, a sound wave reverberation apparatus is provided. The apparatus includes processing circuitry configured to obtain attenuation parameters of a plurality of image sound sources corresponding to a sound source and delay durations of the image sound sources, the image sound sources being configured to simulate a sound wave that is emitted by the sound source and reaches a receiver after being reflected, the attenuation parameters indicating intensities of sound waves from the image sound sources and received by the receiver, and the delay durations being durations of travel of the sound waves from the image sound sources to the receiver. The processing circuitry is configured to determine an impulse response of each of the image sound sources based on an impulse function and the delay duration of the respective image sound source. The processing circuitry is configured to, for each of the image sound sources, perform convolution on a first sound wave, the attenuation parameter of the respective image sound source, and the impulse response of the respective image sound source to obtain a second sound wave corresponding to the respective image sound source, the first sound wave being a sound wave emitted by the sound source and received by the receiver, and the second sound wave corresponding to the respective image sound source being a sound wave emitted by the respective image sound source and received by the receiver. The processing circuitry is configured to generate a target sound wave based on superposition of the obtained second sound waves.

According to an aspect, a non-transitory computer-readable storage medium is provided. The non-transitory computer-readable storage medium stores instructions, which when executed by a processor, cause the processor to perform a sound wave reverberation method. In the method, attenuation parameters of a plurality of image sound sources corresponding to a sound source and delay durations of the image sound sources are obtained, the image sound sources being configured to simulate a sound wave that is emitted by the sound source and reaches a receiver after being reflected, the attenuation parameters indicating intensities of sound waves from the image sound sources and received by the receiver, and the delay durations being durations of travel of the sound waves from the image sound sources to the receiver. An impulse response of each of the image sound sources is determined based on an impulse function and the delay duration of the respective image sound source. For each of the image sound sources, convolution is performed on a first sound wave, the attenuation parameter of the respective image sound source, and the impulse response of the respective image sound source to obtain a second sound wave corresponding to the respective image sound source, the first sound wave being a sound wave emitted by the sound source and received by the receiver, and the second sound wave corresponding to the respective image sound source being a sound wave emitted by the respective image sound source and received by the receiver. In the method, a target sound wave is generated based on superposition of the obtained second sound waves.

According to an aspect, a sound wave reverberation method is provided, the method including: obtaining attenuation parameters of at least two image sound sources corresponding to a sound source and delay durations of the at least two image sound sources, the image sound sources being configured to simulate a sound wave emitted by the sound source and reaching a receiver after being reflected, the attenuation parameters indicating intensities of sound waves emitted by the image sound sources and received by the receiver, and the delay durations being durations for the sound waves emitted by the image sound sources to reach the receiver; determining an impulse response of each image sound source based on a pulse function and the delay duration of each image sound source; performing convolution, for each image sound source, on a first sound wave, the attenuation parameter of the image sound source, and the impulse response of the image sound source to obtain a second sound wave, the first sound wave being a sound wave emitted by the sound source and received by the receiver, and the second sound wave being a sound wave emitted by the image sound source and received by the receiver; and superposing the at least two obtained second sound waves to obtain a target sound wave.

According to another aspect, a sound wave reverberation apparatus is provided, the apparatus including: an obtaining module, configured to obtain attenuation parameters of at least two image sound sources corresponding to a sound source and delay durations of the at least two image sound sources, the image sound sources being configured to simulate a sound wave emitted by the sound source and reaching a receiver after being reflected, the attenuation parameters indicating intensities of sound waves emitted by the image sound sources and received by the receiver, and the delay durations being durations for the sound waves emitted by the image sound sources to reach the receiver; a determining module, configured to determine an impulse response of each image sound source based on a pulse function and the delay duration of each image sound source; a convolution module, configured to perform convolution, for each image sound source, on a first sound wave, the attenuation parameter of the image sound source, and the impulse response of the image sound source to obtain a second sound wave, the first sound wave being a sound wave emitted by the sound source and received by the receiver, and the second sound wave being a sound wave emitted by the image sound source and received by the receiver; and a superposing module, configured to superpose the at least two obtained second sound waves to obtain a target sound wave.

According to another aspect, a computer device is provided, the computer device including processing circuitry (e.g., a processor) and a memory (e.g., including a non-transitory computer-readable storage medium), the memory having at least one computer program stored therein, the at least one computer program being loaded and executed by the processor to implement the operations performed in the sound wave reverberation method in one or more foregoing aspects.

According to another aspect, a computer-readable storage medium (e.g., non-transitory computer-readable storage medium) is provided, having at least one computer program stored therein, the at least one computer program being loaded and executed by processing circuitry (e.g., a processor) to implement the operations performed in one or more sound wave reverberation method in one or more foregoing aspects.

According to still another aspect, a computer program product is provided, including a computer program, the computer program, when executed by processing circuitry (e.g., a processor), implementing the operations performed in the sound wave reverberation method in one or more foregoing aspects.

In one or more embodiments of this disclosure, considering that in a process in which the sound source emits the sound wave, the sound wave received by the receiver includes noise when the sound source and the receiver move relatively, and considering that the sound wave emitted by the sound source may directly reach the receiver or may reach the receiver after being reflected, an image sound source of the sound source is configured to simulate the sound wave emitted by the sound source and reaching the receiver after being reflected, and the image sound source of the sound source is considered as another individually movable sound source. The attenuation parameter of the image sound source can reflect the intensity of the sound wave from the image sound source (e.g., simulated as being emitted by the image sound source, or simply referred to as emitted by the image sound source in this disclosure) when the sound wave reaches the receiver, and the delay duration of the image sound source is the duration (e.g., a duration of travel) for the sound wave emitted by the image sound source to reach the receiver. Therefore, the attenuation parameters of the at least two image sound sources and the delay durations of the at least two image sound sources are used in combination with the first sound wave directly (e.g., along a direct path without any further reflection) reaching the receiver after being emitted by the sound source, the second sound wave directly (e.g., along a direct path without any further reflection) reaching the receiver after being emitted by each image sound source is simulated, and then the second sound waves corresponding to the at least two image sound sources are superposed, to obtain a reverberated sound wave, so that the reverberated sound wave can simulate a result that the receiver receives the second sound waves emitted by the at least two image sound sources, to simulate a reverberation effect after all sound waves emitted by the sound source reach the receiver after being reflected. The foregoing process of obtaining the target sound wave by using the attenuation parameters and the delay durations of the image sound sources implements a sound wave reverberation method. This sound wave reverberation method can be applicable to a situation where a sound source and a receiver move relatively. Even in the situation where the sound source and the receiver move relatively, a sound wave after reverberation can contain less noise, improving quality of the sound wave after reverberation and rendering an improved reverberation effect.

### BRIEF DESCRIPTION OF THE DRAWINGS

FIG. 1 is a schematic structural diagram of an implementation environment according to an embodiment of this disclosure.

FIG. 2 is a flowchart of a sound wave reverberation method according to an embodiment of this disclosure.

FIG. 3 is a flowchart of a sound wave reverberation method according to an embodiment of this disclosure.

FIG. 4 is a schematic diagram of a relationship between a sound source and an image sound source according to an embodiment of this disclosure.

FIG. 5 is a schematic diagram of at least two image sound sources corresponding to a sound source according to an embodiment of this disclosure.

FIG. 6 is a flowchart of a sound wave reverberation method according to an embodiment of this disclosure.

FIG. 7 is a schematic diagram of motion trajectories of a sound source and at least two image sound sources according to an embodiment of this disclosure.

FIG. 8 is a schematic diagram of a filter architecture according to an embodiment of this disclosure.

FIG. 9 is a schematic diagram of a motion displacement, a delay duration, and an attenuation parameter according to an embodiment of this disclosure.

FIG. 10 is a flowchart of a sound wave reverberation method according to an embodiment of this disclosure.

FIG. 11 is a schematic diagram of a sound wave according to an embodiment of this disclosure.

FIG. 12 is a schematic diagram of a virtual battle interface according to an embodiment of this disclosure.

FIG. 13 is a schematic structural diagram of a sound wave reverberation apparatus according to an embodiment of this disclosure.

FIG. 14 is a schematic structural diagram of a terminal according to an embodiment of this disclosure.

FIG. 15 is a schematic structural diagram of a server according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Terms “first”, “second”, and the like used in this disclosure may be configured for describing various concepts in this disclosure. However, unless otherwise specified, these concepts are not limited by these terms. These terms are configured for distinguishing one concept from another. For example, without departing from the scope of this disclosure, a first sound wave may be referred to as a second sound wave, and similarly, the second sound wave may be referred to as the first sound wave.

In terms “at least one”, “a plurality of”, “each”, and “any one” used in this disclosure, “at least one” includes one, two, or more, “at least two” includes two or more, and “a plurality of” includes two or more. In one or more embodiments of this disclosure, “a plurality of” is equivalent to at least two. “Each” refers to each in corresponding “a plurality of”, and “any one” refers to any one in “a plurality of”. For example, a plurality of image sound sources include three image sound sources. In this case, “each” refers to each image sound source of the three image sound sources, and “any one” refers to any one of the three image sound sources, which may be the first image sound source, the second image sound source, or the third image sound source.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Information (including but not limited to user device information, user personal information, and the like), data (including but not limited to data for analysis, stored data, displayed data, and the like), and signals involved in this disclosure are all authorized by users or fully authorized by all parties, and collection, use, and processing of relevant data need to comply with relevant laws, regulations, and standards of relevant countries and regions. For example, sound waves involved in this disclosure are obtained with full authorization.

For a sound wave reverberation solution in some other examples, a reverberation effect is poor, resulting in poor quality of a sound wave received by a receiver.

A sound wave reverberation method provided in one or more embodiments of this disclosure is performed by a computer device. In some embodiments, the computer device is a terminal or a server. In some embodiments, the server is an independent physical server. In some embodiments, the terminal is a smart phone, a tablet computer, a notebook computer, a desktop computer, a smart speaker, a smart watch, a smart voice interaction device, a smart household appliance, an on-board terminal, or the like, but is not limited thereto.

In some embodiments, the computer device is provided as a server. FIG. 1 is a schematic diagram of an implementation environment according to an embodiment of this disclosure. Referring to FIG. 1, the implementation environment includes a terminal 101 and a server 102. The terminal 101 is connected to the server 102 by using a wireless or wired network. The terminal 101 includes the receiver.

The terminal 101 is configured to receive a sound wave emitted by a sound source through the receiver. To be specific, the receiver receives a first sound wave, and transmits the first sound wave to the server 102. The server 102 is configured to receive the first sound wave. For the sound source, based on the first sound wave, sound waves that are emitted by at least two image sound sources of the sound source and that are received by the receiver are obtained. To be specific, at least two second sound waves are obtained, and then the at least two second sound waves are superposed to obtain a target sound wave. The target sound wave is equivalent to a sound wave after reverberation.

In some embodiments, an application for which the server 102 provides services is installed on the terminal 101, and the terminal 101 can acquire sound waves through the application. In some embodiments, the application is either a built-in application in an operating system of the terminal 101 or an application provided by a third-party. For example, the application is a game application, and the game application has a game function. The game application can also have other functions, such as a review function, a shopping function, and a navigation function. The terminal 101 is configured to log into the application based on an account, receive the sound wave emitted by the sound source through the receiver, and transmit the sound wave received by the receiver to the server 102 through the application.

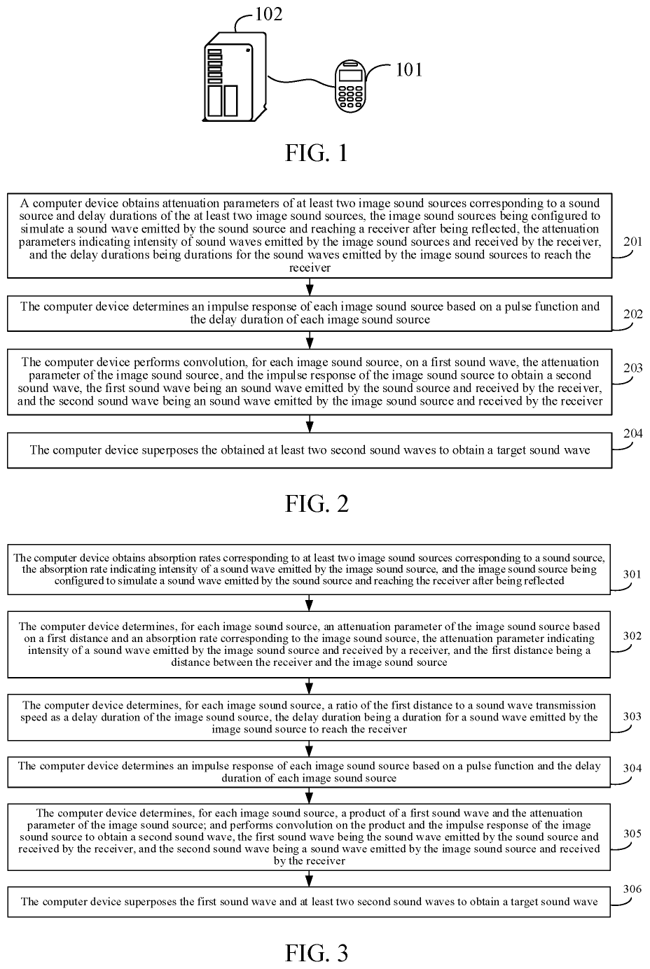

FIG. 2 is a flowchart of a sound wave reverberation method according to an embodiment of this disclosure. The method is performed by the computer device. As shown in FIG. 2, the method includes the following operations.

201: A computer device obtains attenuation parameters of at least two image sound sources corresponding to a sound source and delay duration of the at least two image sound sources, the image sound sources being configured to simulate a sound wave emitted by the sound source and reaching a receiver after being reflected, the attenuation parameters indicating intensity of a sound wave emitted by the image sound source and received by the receiver, and the delay duration being a duration for the sound wave emitted by the image sound source to reach the receiver.

In some examples, attenuation parameters of a plurality of image sound sources corresponding to a sound source and delay durations of the image sound sources are obtained. The image sound sources are configured to simulate a sound wave that is emitted by the sound source and reaches a receiver after being reflected. The attenuation parameters indicate intensities of sound waves from the image sound sources and received by the receiver, and the delay durations are durations of travel of the sound waves from the image sound sources to the receiver.

In one or more embodiments of this disclosure, the sound source is located in a space, and the sound source emits a sound wave to the surroundings. After the sound wave emitted by the sound source encounters an obstacle in the space, the sound wave is reflected by the obstacle. The reflected sound wave is equivalent to a sound wave emitted by an image sound source that is symmetrical about the obstacle. In this case, at least two image sound sources of the sound source can be determined based on the obstacle in the space, so as to convert a reflection situation of the sound wave emitted by the sound source into a propagation situation of the sound wave emitted by the at least two image sound sources, so that a sound wave that is emitted by the sound source and is not reflected, or a sound wave that is emitted by the sound source and is reflected, which is received by the receiver, can be subsequently determined.

The sound source is located in any space. For example, the sound source is located in a room or another space including an obstacle.

For example, the sound source is located at a position in the room, and the room includes a plurality of walls, a ceiling, and a floor. A sound wave emitted by the sound source reflects off a wall of the room. Therefore, it can be determined that there is an image sound source of the sound source on the other side of the wall. The image sound source is also referred to as a virtual sound source. The image sound source and the sound source are symmetrical about the wall. A reflected sound wave is equivalent to a sound wave directly emitted by the image sound source. In the foregoing mode, a plurality of image sound sources of the sound source can be obtained based on the plurality of walls, the ceiling, and the floor of the room.

In one or more embodiments of this disclosure, the sound source emits sound waves to the surroundings, some of the sound waves emitted by the sound source are directly propagated to the receiver, and the some of the sound waves are referred to as direct sound waves. In addition, some sound waves emitted by the sound source are reflected by the obstacle and then propagated to the receiver. The sound waves received by the receiver include direct sound waves and sound waves reflected by the obstacle. The reflected sound waves that are received by the receiver are equivalent to sound waves emitted by any image sound source to the receiver, namely, direct sound waves emitted by any image sound source to the receiver. A time at which the sound wave reflected by the obstacle reaches the receiver is referred to as a first time, and a time at which the direct sound wave emitted by the sound source reaches the receiver is referred to as a second time. Considering that the first time is later than the second time, and when the sound wave is reflected by the obstacle, the obstacle may also absorb some energy of the sound wave, resulting in reduced intensity of the sound wave reflected by the obstacle, the attenuation parameters of the at least two image sound sources and the delay durations of the at least two image sound sources are obtained, so as to subsequently determine the direct sound wave emitted by each image sound source to the receiver, to simulate a reflection situation of the sound wave emitted by the sound source, and further determine the sound wave received by the receiver.

The attenuation parameter can be represented in any form. For example, the attenuation parameter is equivalent to an amplitude of a sound wave, the amplitude can reflect sound wave strength, and the sound wave strength refers to sound wave energy passing through a unit area perpendicular to a sound wave propagation direction per unit time. A larger amplitude indicates higher sound wave strength, and a smaller amplitude indicates lower sound wave strength. The delay duration is equivalent to a duration for the sound wave emitted by the sound source to reach the receiver through reflection by the obstacle. The receiver can be any type of receiver. For example, the receiver is a microphone. The sound wave is any type of sound wave. For example, the sound wave is a speech signal.

In one or more embodiments of this disclosure, the image sound source is used for simulating a sound wave emitted by the sound source and reaching the receiver after being reflected. The sound wave simulated by the image sound source is equivalent to a direct sound wave emitted by the image sound source and reaching the receiver. The attenuation parameter of the image sound source is also equivalent to the sound wave strength when the direct sound wave corresponding to the image sound source reaches the receiver. The delay duration of the image sound source is also equivalent to a duration for the direct sound wave corresponding to the image sound source to reach the receiver from the image sound source.

202: The computer device determines an impulse response of each image sound source based on a pulse function and the delay duration of each image sound source.

In some examples, an impulse response of each of the image sound sources is determined based on an impulse function and the delay duration of the respective image sound source.

In one or more embodiments of this disclosure, the delay duration of the image sound source is a propagation duration for the sound wave emitted by the image sound source to reach the receiver from the image sound source. The pulse function is used for describing an instantaneous delay duration of the sound wave. The impulse response of the image sound source is determined based on the pulse function and the delay duration of the image sound source, so as to reflect a propagation situation of the sound wave emitted by the image sound source to the receiver.

The pulse function is used for describing an instantaneous physical quantity. In one or more embodiments of this disclosure, the pulse function is used for describing an instantaneous sound wave. The pulse function can be any type of pulse function. For example, the pulse function is a & function. For example, the pulse function is a time-variant pulse function, the impulse response is a time-variant impulse response, and the time-variant impulse response outputted by the time-variant pulse function varies with time. In a case that an input of the time-variant pulse function is equal to 0, the time-variant impulse response is positive infinity. In a case that the input of the time-variant pulse function is not equal to 0, the time-variant impulse response is another value. In addition, a value obtained by integrating the time-variant pulse function in a time dimension is 1. The impulse response of the image sound source is used for representing a propagation situation of the sound wave emitted by the image sound source to the receiver, and is also equivalent to a reflection situation when the sound wave is emitted by the sound source and then propagated to the receiver. The impulse response is used for representing an impact of the image sound source on reception of the sound wave by the receiver, which can reflect an impact of the sound wave emitted by the image sound source and received by the receiver on a direct sound wave emitted by the sound source and received by the receiver.

In one or more embodiments of this disclosure, the impulse response of the image sound source is related to the delay duration of the image sound source. The delay duration of the image sound source is related to a position of the image sound source. The position of the image sound source changes as a position of the sound source changes. Therefore, in a case that the position of the sound source changes with time or in a case that the position of the receiver changes with time, that is, in a case that the sound source is a moving sound source or the receiver is a moving receiver, the impulse response of the image sound source changes with time. In a case that the sound source moves, the image sound source corresponding to the sound source is a moving image sound source. The position of the image sound source can be represented in any form. For example, the position of the image sound source is represented by coordinates in a world coordinate system.

203: The computer device convolves, for each image sound source, a first sound wave, the attenuation parameter of the image sound source, and the impulse response of the image sound source to obtain a second sound wave, the first sound wave being a sound wave emitted by the sound source and received by the receiver, and the second sound wave being a sound wave emitted by the image sound source and received by the receiver.

In some examples, for each of the image sound sources, convolution is performed on a first sound wave, the attenuation parameter of the respective image sound source, and the impulse response of the respective image sound source to obtain a second sound wave corresponding to the respective image sound source. The first sound wave is a sound wave emitted by the sound source and received by the receiver, and the second sound wave corresponding to the respective image sound source is a sound wave emitted by the respective image sound source and received by the receiver.

In one or more embodiments of this disclosure, the attenuation parameter of the image sound source can reflect intensity of a sound wave emitted by the image sound source and received by the receiver. The delay duration is the duration for the sound wave emitted by the image sound source to reach the receiver. The first sound wave, the attenuation parameter of the image sound source, and the impulse response of the image sound source are convolved to obtain the second sound wave, which is equivalent to a sound wave that is directly emitted by the image sound source to the receiver and that is received by the receiver, and is equivalent to a direct sound wave emitted by the image sound source and received by the receiver. One second sound wave can be obtained for each image sound source, and then a second sound wave corresponding to each image sound source can be obtained according to the foregoing operation. To be specific, at least two second sound waves are obtained. The first sound wave is a sound wave that is emitted by the sound source, is not reflected, and is received by the receiver.

In one or more embodiments of this disclosure, the first sound wave and the second sound wave are both data used for describing a waveform signal, and subsequently, a waveform signal having a physical meaning can be generated based on the second sound wave. Alternatively, the first sound wave is a waveform signal having a physical meaning. The foregoing process of performing convolution on the first sound wave, the attenuation parameter of the image sound source, and the impulse response of the image sound source is equivalent to a process of generating a waveform signal having a physical meaning. Therefore, the generated second sound wave is a waveform signal having a physical meaning.

204: The computer device superposes the obtained at least two second sound waves to obtain a target sound wave.

In some examples, a target sound wave is generated based on superposition of the obtained second sound waves.

In one or more embodiments of this disclosure, the receiver can receive the sound wave emitted by each image sound source, and then the at least two second sound waves are superposed, so as to reverberate the sound wave emitted by the sound source. The obtained target sound wave is equivalent to a sound wave after reverberation.

In one or more embodiments of this disclosure, the second sound wave may be data used for describing a waveform signal, or may be a waveform signal having a physical meaning. In a case that the second sound wave may be data used for describing a waveform signal, the obtained target sound wave is also data used for describing a reverberated waveform signal, and subsequently, a waveform signal having a physical meaning can be generated based on the target sound wave. In a case that the second sound wave is a waveform signal having a physical meaning, the process of superposing the at least two second sound waves is also equivalent to a process of generating a reverberated waveform signal, and the obtained target sound wave is a waveform signal having a physical meaning.

In one or more embodiments of this disclosure, considering that in a process in which the sound source emits the sound wave, the sound wave received by the receiver includes noise when the sound source and the receiver move relatively, and considering that the sound wave emitted by the sound source may directly reach the receiver or may reach the receiver after being reflected, the image sound source of the sound source is configured to simulate the sound wave emitted by the sound source and reaching the receiver after being reflected, and the image sound source of the sound source is considered as an individual that moves independently. The attenuation parameter of the image sound source can reflect the intensity of the sound wave emitted by the image sound source when the sound wave reaches the receiver, and the delay duration of the image sound source is the duration for the sound wave emitted by the image sound source to reach the receiver. Therefore, the attenuation parameters of the at least two image sound sources and the delay durations of the at least two image sound sources are used in combination with the first sound wave directly reaching the receiver after being emitted by the sound source, the second sound wave directly reaching the receiver after being emitted by each image sound source is simulated, and then the second sound waves corresponding to the at least two image sound sources are superposed, to obtain a sound wave after reverberation, so that the sound wave after reverberation can simulate a result that the receiver receives the second sound waves emitted by the at least two image sound sources, to simulate a reverberation effect after all sound waves emitted by the sound source reach the receiver after being reflected. The foregoing process of obtaining the target sound wave by using the attenuation parameters and the delay durations of the image sound sources implements a sound wave reverberation method. This sound wave reverberation method can be applicable to a situation where a sound source and a receiver move relatively. Even in the situation where the sound source and the receiver move relatively, a sound wave after reverberation can contain less noise, improving quality of the sound wave after reverberation and a reverberation effect.

Based on the non-limiting example of FIG. 2, in one or more embodiments of this disclosure, the attenuation parameter or the delay duration of the image sound source can be obtained by using the absorption rate corresponding to the image sound source, the distance between the receiver and the image sound source, the sound wave transmission speed, and the like, and the second sound wave can be obtained in a convolutional mode. For a specific process, reference is made to the following embodiment.

FIG. 3 is a flowchart of a sound wave reverberation method according to an embodiment of this disclosure. The method is performed by a computer device. As shown in FIG. 3, the method includes the following operations.

301: The computer device obtains absorption rates corresponding to at least two image sound sources corresponding to a sound source, the absorption rate indicating intensity of a sound wave emitted by the image sound source, and the image sound source being configured to simulate a sound wave emitted by the sound source and reaching a receiver after being reflected.

In one or more embodiments of this disclosure, a sound wave emitted by the image sound source and received by the receiver is equivalent to a sound wave emitted by the sound source and received by the receiver after being reflected by an obstacle. Energy is absorbed by the obstacle from the sound wave when it is reflected by the obstacle, so that a reflected sound wave has reduced energy. The absorption rate can reflect intensity of a sound wave after reflection by the obstacle. The absorption rate corresponding to each image sound source is obtained to subsequently determine intensity of a sound wave emitted by each image sound source to the receiver.

The absorption rate can be represented in any form. For example, the absorption rate is represented in a value form.

In an implementation example, a process of obtaining the absorption rate corresponding to the image sound source includes: determining the absorption rate corresponding to the image sound source based on a room parameter of a room where the sound source is located.

The room parameter indicates an absorption rate of each wall, ceiling, or floor of the room. The absorption rate of the wall indicates intensity of a sound wave reflected by the wall. For example, when a sound wave encounters the wall, the wall not only reflects the sound wave, but also absorbs energy of the sound wave, resulting in reduced strength of the reflected sound wave. The absorption rate can reflect or indicate the intensity of the sound wave reflected by the wall.

In one or more embodiments of this disclosure, because an image sound source may be obtained by symmetrically mirroring a sound source about any wall surface of a room, or may be obtained by symmetrically mirroring another image sound source about a plurality of wall surfaces of the room, an absorption rate corresponding to each image sound source can be determined based on the room parameter of the room.

In some embodiments, a process of determining an absorption rate corresponding to an image sound source based on the room parameter includes: determining, for any image sound source, at least one target wall surface, the image sound source being obtained by symmetrically mirroring a sound source for one or more times about the at least one target wall surface; determining an absorption rate of the at least one target wall surface based on a room parameter of a room; and determining the absorption rate of the at least one target wall surface as the absorption rate corresponding to the image sound source.

In one or more embodiments of this disclosure, any image sound source is obtained by symmetrically mirroring a sound source about any wall surface of a room, or is obtained by symmetrically mirroring another image sound source about a plurality of surfaces of the room. In a case that an image sound source is obtained by symmetrically mirroring a sound source about one wall surface of a room, the absorption rate corresponding to the image sound source is an absorption rate of the wall surface. In a case that an image sound source is obtained by symmetrically mirroring a sound source about a plurality of wall surfaces of a room, the image sound source is actually obtained by symmetrically mirroring another image sound source about any wall surface of the room, and a sum of absorption rates of the plurality of wall surfaces is the absorption rate corresponding to the image sound source.

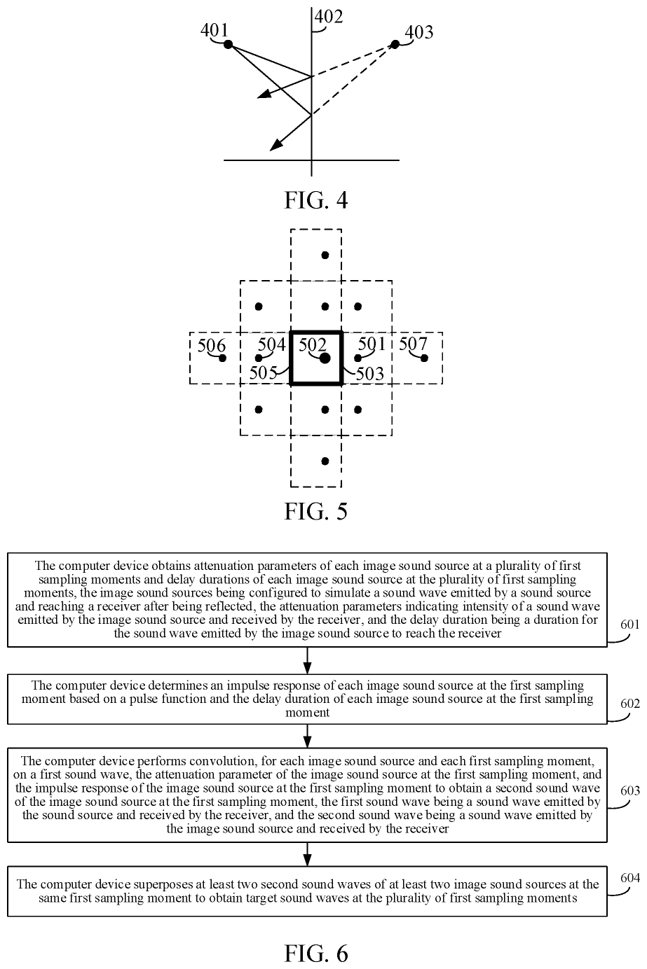

For example, a sound source is located in any room. As shown in FIG. 4, a sound source 401 is symmetrically mirrored about a wall 402 to obtain an image sound source 403. A sound wave emitted by the sound source 401 is subjected to a direction change after being reflected by the wall, and the sound wave after the direction change is equivalent to a sound wave directly emitted by the image sound source 403. Therefore, a sound wave emitted by the sound source and received by a receiver after being reflected is equivalent to a sound wave emitted by an image sound source and received by the receiver. At least two image sound sources corresponding to the sound source are shown in FIG. 5. An image sound source 501 is obtained by symmetrically mirroring a sound source 502 about a wall 503 of a room. An image sound source 504 is obtained by symmetrically mirroring the sound source 502 about a wall 505 of the room. An image sound source 506 is obtained by symmetrically mirroring the image sound source 501 about the wall 505 of the room. An image sound source 507 is obtained by symmetrically mirroring the image sound source 504 about the wall 503 of the room, and so forth, 12 image sound sources of the sound source 502 can be obtained. An absorption rate corresponding to the image sound source 501 is an absorption rate of the wall 503, an absorption rate corresponding to the image sound source 504 is an absorption rate of the wall 505, an absorption rate corresponding to the image sound source 506 is a sum of the absorption rates of the wall 503 and the wall 505, and an absorption rate corresponding to the image sound source 507 is a sum of the absorption rates of the wall 503 and the wall 505. In addition, a dashed box including the image sound source 501 is equivalent to a mirror room of the room. Similarly, each dashed box in FIG. 5 is equivalent to the mirror room of the room, i.e., a virtual room of the room.

In one or more embodiments of this disclosure, for an image sound source obtained by symmetrically mirroring a sound source about any wall surface, a sound wave emitted by the image sound source is equivalent to a sound wave emitted by the sound source and reflected by the wall surface. For an image sound source obtained by symmetrically mirroring a sound source about a plurality of surfaces, a sound wave emitted by the image sound source is equivalent to a sound wave emitted by the sound source and reflected by the plurality of surfaces. When a sound wave emitted by the sound source is reflected by any wall surface, the surface may absorb some energy, resulting in reduced energy of a reflected sound wave. An absorption rate of the surface can reflect an absorption degree of energy of the sound wave by the surface, and further reflect energy strength of the reflected sound wave. Therefore, the absorption rate corresponding to the image sound source can be determined based on an absorption rate of target wall surface corresponding to the image sound source, such that an absorption rate may be related to a wall of a room where a sound source is located and simulating a situation in which a sound wave is reflected in a room in a real scenario to improve accuracy of an absorption rate corresponding to an image sound source.

In an implementation example, a process of determining a plurality of image sound sources of a sound source includes: determining an image sound source symmetrical with the sound source about a wall, an image sound source symmetrical with the sound source about a ceiling, and an image sound source symmetrical with the sound source about a floor based on a position of the sound source in the room, a position of the wall of the room, a position of the ceiling of the room, and a position of the floor of the room. For currently determined any one image sound source, based on a position of the image sound source, the position of the wall of the room, the position of the ceiling of the room, and the position of the floor of the room, an image sound source symmetrical with the image sound source about the wall, an image sound source symmetrical with the currently determined any one image sound source about the ceiling, an image sound source symmetrical with the currently determined any one image sound source about the floor are determined, and so forth, at least two image sound sources of the sound source are obtained. The foregoing positions can be represented in any form. For example, the positions are represented by coordinates in the world coordinate system.

In some embodiments, a quantity of image sound sources is related to a reverberation time. In the process of determining the image sound sources in the foregoing mode, a product of the reverberation time and a sound wave transmission speed is determined, and distances between at least two image sound sources of a sound source and a receiver are less than the product.

In one or more embodiments of this disclosure, when an image sound source is determined as described above, a longer distance between the image sound source and the receiver indicates a longer duration for a sound wave emitted by the image sound source to reach the receiver and indicates a longer reverberation time. A sound wave transmission speed represents a propagation speed of a sound wave in a medium, and in a case that a reverberation time has been determined, a product of the sound wave transmission speed and the reverberation time is equivalent to a maximum transmission distance of a sound wave that can be received by a receiver in a process of performing reverberation on a sound wave emitted by a sound source. For any image sound source, a distance between the image sound source and the receiver is a distance by which a direct sound wave emitted by the image sound source reaches the receiver. Therefore, the distances between the at least two image sound sources and the receiver are less than the product, so that there may be sufficient processing time for a subsequent reverberation for the sound wave emitted by the sound source. The medium is a medium of any type. For example, the medium is air, water, or the like.

302: The computer device determines, for each image sound source, an attenuation parameter of the image sound source based on a first distance and an absorption rate corresponding to the image sound source, the attenuation parameter indicating intensity of a sound wave emitted by the image sound source and received by a receiver, and the first distance being a distance between the receiver and the image sound source.

In some examples, for a current image sound source of the image sound sources, an absorption rate corresponding to the current image sound source is obtained at block 301, and the attenuation parameter of the current image sound source is determined based on a first distance and the absorption rate, the first distance being a distance between the receiver and the current image sound source at block 302.

In one or more embodiments of this disclosure, the sound wave emitted by the image sound source to the receiver is equivalent to a sound wave that is the sound wave emitted by the sound source and reaches the receiver after being reflected by an obstacle. Energy is absorbed by the obstacle from the sound wave when it is reflected by the obstacle, so that a reflected sound wave has reduced energy. The absorption rate can reflect intensity of a sound wave after reflection by the obstacle. The absorption rate corresponding to the image sound source can indicate intensity of the sound wave emitted by the image sound source and received by the receiver. In addition, considering that an intensity of a sound wave decreases with an increasing propagation distance as the sound wave propagates, the intensity of the sound wave emitted by the image sound source and received by the receiver is not only related to the absorption rate corresponding to the image sound source, but also related to a distance between the receiver and the image sound source. Therefore, the attenuation parameter of the image sound source is determined based on the distance between the receiver and the image sound source and the absorption rate corresponding to the image sound source, and an energy loss for a sound wave when reflected and an energy loss for a sound wave during a propagation process are considered, so that the attenuation parameter can accurately reflect the intensity of the sound wave emitted by the image sound source and received by the receiver, thereby improving accuracy of the attenuation parameter of the image sound source.

In an implementation example, operation 302 includes: determining the attenuation parameter of the image sound source based on the first distance, the absorption rate corresponding to the image sound source, and a phase change parameter corresponding to the image sound source.

The phase change parameter indicates a phase change situation of the sound wave emitted by the image sound source and received by the receiver compared with the sound wave emitted by the sound source. The phase change parameter is related to a number of times of reflection for the sound wave emitted by the image sound source and received by the receiver. In some embodiments, the phase change parameter is a value with a base of −1 and a power of number of times of reflection.

In one or more embodiments of this disclosure, the sound wave emitted by the image sound source and received by the receiver is equivalent to a sound wave that is the sound wave emitted by the sound source and reaches the receiver after being reflected for multiple times, and the number of times of reflection is the number of times of reflection corresponding to the image sound source. In one or more embodiments of this disclosure, in a propagation process, after each time of reflection, a sound wave undergoes a 180-degree phase change. Therefore, based on a phase change parameter, a phase change of a sound wave emitted by an image sound source can be determined to improve accuracy of an attenuation parameter.

In an implementation example, operation 302 includes the following two modes.

In a first mode, a ratio of the absorption rate to the first distance is determined as the attenuation parameter of the image sound source.

In one or more embodiments of this disclosure, the intensity of the sound wave emitted by the image sound source and received by the receiver is directly proportional to the absorption rate corresponding to the image sound source and is inversely proportional to the propagation distance of the sound wave, namely, the first distance. Therefore, the ratio of the absorption rate to the distance is determined as the attenuation parameter of the image sound source such that the attenuation parameter can reflect a propagation situation of the sound wave emitted by the image sound source and improve accuracy of the attenuation parameter.

In a second mode, a product of the first distance and a target value is determined, and a ratio of the absorption rate to the product is determined as the attenuation parameter of the image sound source.

The target value is any value. For example, the target value is 4π.

In one or more embodiments of this disclosure, the target value is equivalent to a zoom factor of the first distance. Considering that the intensity of the sound wave emitted by the image sound source and received by the receiver is directly proportional to the absorption rate corresponding to the image sound source and is inversely proportional to the first distance, the intensity of the sound wave emitted by the image sound source and received by the receiver and the first distance are zoomed based on the target value. Therefore, the product of the first distance and the target value is determined, and the ratio of the absorption rate to the product is determined as the attenuation parameter of the image sound source such that the attenuation parameter can reflect a propagation situation of the sound wave emitted by the image sound source and improve accuracy of the attenuation parameter.

In some embodiments, the second mode includes: determining a first product and a second product, the first product being a product of the absorption rate and the phase change parameter, the second product being a product of the first distance and the target value; and determining a ratio of the first product to the second product as the attenuation parameter of the image sound source. For example, the absorption rate is 0.1, and the sound wave has a 180-degree phase change, namely, a number of times of reflection being 1, the first product is −0.1.

In some embodiments, the attenuation parameter of the image sound source satisfies the following relationship:

$${A}_{i} ( t ) = \frac{{β}_{i}}{4 π {d}_{i} ( t )}$$

$${d}_{i} ( t ) = ‖ {p}_{r} - {p}_{s} ‖$$

Aᵢ(t) is used for representing an attenuation parameter of an i^{th} image sound source at a moment t, i is an integer greater than 0, βᵢ is used for representing a product of an absorption rate corresponding to an i^{th} image sound source and a phase change parameter, i.e., the first product, 4π is used for representing a target value, dᵢ(t) is used for representing a distance between an i^{th} image sound source and a receiver at a moment t, i.e., the first distances corresponding to the i^{th} image sound source at the moment t, pᵣ is used for representing a position of the i^{th} image sound source at the moment t, and pₛ is used for representing a position of the receiver.

303: The computer device determines, for each image sound source, a ratio of the first distance to the sound wave transmission speed as a delay duration of the image sound source, the delay duration being a duration for a sound wave emitted by the image sound source to reach the receiver.

In some examples, for a current image sound source of the image sound sources, a ratio of a first distance to a sound wave transmission speed is determined as the delay duration of the current image sound source, the first distance being the distance between the receiver and the current image sound source.

In one or more embodiments of this disclosure, after the image sound source emits the sound wave to the receiver, the sound wave propagates to the receiver at the sound wave transmission speed. The first distance is a distance between the receiver and the image sound source, and the ratio of the first distance to the sound wave transmission speed is a duration for the sound wave emitted by the image sound source to reach the receiver.

In one or more embodiments of this disclosure, the sound wave emitted by the image sound source and received by the receiver is equivalent to a sound wave that is the sound wave emitted by the sound source and received by the receiver after being reflected by an obstacle for one or more times. The distance between the image sound source and the receiver is equal to a distance by which the sound wave emitted by the sound source reaches the receiver after the sound wave is reflected by the obstacle for one or more times. Therefore, the ratio of the first distance to the sound wave transmission speed is determined as a delay duration of the image sound source, such that the delay duration can reflect the duration for the sound wave emitted by the image sound source to reach the receiver, thereby improving accuracy of the delay duration.

In an implementation example, the delay duration of the image sound source satisfies the following relationship:

$${τ}_{i} ( t ) = \frac{{d}_{i} ( t )}{c}$$

τᵢ(t) is used for representing a delay duration of an i^{th} image sound source at a moment t, dᵢ(t) is used for representing a distance between the i^{th} image sound source and the receiver at the moment t, and c is used for representing a sound wave transmission speed.

For descriptions in at least one embodiment of this disclosure, the attenuation parameter of the image sound source is obtained by using the absorption rate corresponding to the image sound source and the delay duration of the image sound source is obtained by using the sound wave transmission speed. In another embodiment, the foregoing operations 301 to 303 do not need to be performed, and the attenuation parameters of the at least two image sound sources corresponding to the sound source and the delay durations of the at least two image sound sources are obtained through another mode.

304: The computer device determines an impulse response of each image sound source based on a pulse function and the delay duration of each image sound source.

In an implementation example, operation 304 includes: invoking the pulse function to calculate a target duration and the delay duration of the image sound source to obtain the impulse response of the image sound source, the target duration being a duration for the sound wave emitted by the sound source without reflection to reach the receiver. In some examples, a target duration and the delay duration of the current image sound source are applied to the impulse function to obtain the impulse response of the current image sound source, the target duration being a duration of travel of the sound wave emitted by the sound source to the receiver without reflection.

In one or more embodiments of this disclosure, the receiver not only can receive the sound wave emitted by the sound source without reflection, but also can receive the sound wave that is emitted by the sound source and is reflected. The sound wave that is emitted by the sound source and is reflected is equivalent to the sound wave emitted by the image sound source. The sound waves received by the receiver are all sound waves emitted by the sound source at the same moment. In the sound waves received by the receiver, the sound wave emitted by the sound source without reflection reaches the receiver first, and the sound wave emitted by the image sound source reaches the receiver later. Therefore, the pulse function is invoked to calculate the target duration and the delay duration of the image sound source to obtain the impulse response of the image sound source, so as to reflect a delay time of the sound wave emitted by the image sound source and received by the receiver, compared with the sound wave emitted by the sound source and received by the receiver without reflection, thereby determining an impact of the sound wave emitted by the image sound source on the receiver and rendering a subsequent reverberation effect.

In an implementation example, the impulse response of the image sound source satisfies the following relationship:

$${Λ}_{i} ( t ) = δ ( {t}^{′} - \frac{{d}_{i} ( t )}{c} )$$

Λᵢ(t) is used for representing an impulse response of an i^{th} image sound source at a moment t, t is any moment, t′ is used for representing a target duration, dᵢ(t) is used for representing a distance between the i^{th} image sound source and the receiver at the moment t, c is used for representing a sound wave transmission speed, δ(⋅) is used for representing a pulse function, and in a case that input of the pulse function is equal to 0, output of the pulse function is positive infinity; in a case that the input of the pulse function is not equal to 0, the output of the pulse function is 0; and a value obtained by integrating the pulse function in a time dimension is 1.

305: The computer device determines, for each image sound source, a product of the first sound wave and the attenuation parameter of the image sound source; and performs convolution on the product and the impulse response of the image sound source to obtain a second sound wave, the first sound wave being a sound wave emitted by the sound source and received by the receiver, and the second sound wave being a sound wave emitted by the image sound source and received by the receiver.

In one or more embodiments of this disclosure, the product of the first sound wave and the attenuation parameter of the image sound source is equivalent to a linear invariant part of the sound wave emitted by the image sound source and received by the receiver and can reflect intensity of the sound wave emitted by the image sound source and received by the receiver. The impulse response of the image sound source is equivalent to a time-variant part of the sound wave emitted by the image sound source and received by the receiver and can reflect a phase of the sound wave emitted by the image sound source and received by the receiver. Convolution is performed on the product of the first sound wave and the attenuation parameter of the image sound source and the impulse response of the image sound source to obtain the sound wave emitted by the image sound source and received by the receiver to improve accuracy of the second sound wave.

In one or more embodiments of this disclosure, the second sound wave corresponding to each image sound source may be obtained in the foregoing mode. To be specific, at least two second sound waves are obtained.

In an implementation example, the second sound wave satisfies the following relationship:

$${u}_{i} ( t ) = s ( t ) {A}_{i} ( t ) ⊗ δ ( t - {τ}_{i} ( t ) )$$

$${A}_{i} ( t ) = \frac{{β}_{i}}{4 π {d}_{i} ( t )}$$

$${τ}_{i} ( t ) = \frac{{d}_{i} ( t )}{c}$$

uᵢ(t) is used for representing a second sound wave of an i^{th} image sound source at a moment t, s(t) is used for representing a first sound wave of a sound source at the moment t, Aᵢ(t) is used for representing an attenuation parameter of the i^{th} image sound source at the moment t, and ⊗ is used for representing a tensor product and is also equivalent to performing convolution on s(t)Aᵢ(t) and δ(t−τᵢ(t)); δ(t−τᵢ(t)) is used for representing an impulse response of the i^{th} image sound source at the moment t, i is an integer greater than 0, τᵢ(t) is used for representing a delay duration of the i^{th} image sound source at the moment t, βᵢ is used for representing a product of an absorption rate corresponding to the i^{th} image sound source and a phase change parameter, 4π is used for representing a target value, and dᵢ(t) is used for representing a distance between the i^{th} image sound source and the receiver at the moment t; and c is used for representing a sound wave transmission speed.

The description is made in one or more embodiments of this disclosure by using an example in which convolution is performed on the product of the first sound wave and the attenuation parameter of the image sound source and the impulse response of the image sound source. In another embodiment, the foregoing operation 305 does not need to be performed, and convolution is performed on the first sound wave, the attenuation parameter of the image sound source, and the impulse response of the image sound source through another mode to obtain the second sound wave.

306: The computer device superposes the first sound wave and the at least two second sound waves to obtain a target sound wave.

In one or more embodiments of this disclosure, the receiver not only can receive the sound wave emitted by the sound source without reflection, but also can receive the sound wave emitted by each image sound source to the receiver. The first sound wave and the at least two second sound waves are superposed to achieve a reverberation effect on the sound wave emitted by the sound source and enrich content included in the target sound wave, so that the target sound wave can reflect a reverberation effect for a sound wave in a real scenario, thereby further improving the reverberation effect for the target sound wave and improving accuracy of the target sound wave.

In an implementation example, operation 306 includes: superposing the first sound wave and the at least two second sound waves in a chronological order to obtain the target sound wave.

In one or more embodiments of this disclosure, considering that sound waves are continuous, in the process of superposing the first sound wave and the at least two second sound waves, sound waves at the same moment are superposed in a chronological order, so that the obtained target sound wave can reflect a reverberation effect for a sound wave in a real scenario, thereby improving accuracy of the target sound wave.

In an implementation example, the target sound wave satisfies the following relationship:

$${\sum }_{i ∈ N} {u}_{i} ( t ) = {\sum }_{i ∈ N} s ( t ) {A}_{i} ( t ) ⊗ δ ( t - {τ}_{i} ( t ) )$$

$${\sum }_{i ∈ N} {u}_{i} ( t )$$

is used for representing a target sound wave, uᵢ(t) is used for representing a second sound wave of an i^{th} image sound source at a moment t, i is an integer greater than 0 and not greater than N, N is a quantity of image sound sources, s(t) is used for representing a first sound wave of a sound source at the moment t, Aᵢ(t) is used for representing an attenuation parameter of the i^{th} image sound source at the moment t, and ⊗ is used for representing a tensor product and is also equivalent to performing convolution on s(t)Aᵢ(t) and δ(t−τᵢ(t)); δ(t−τᵢ(t) is used for representing an impulse response of the i^{th} image sound source at the moment t, and τᵢ(t) is used for representing a delay duration of the i^{th} image sound source at the moment t.

The description is made in one or more embodiments of this disclosure by using an example in which the first sound wave and the at least two second sound waves are superposed. In another embodiment, the foregoing operation 306 does not need to be performed, and the obtained at least two second sound waves are superposed through another mode to obtain the target sound wave.

In one or more embodiments of this disclosure, considering that in a process in which the sound source emits the sound wave, the sound wave received by the receiver includes noise when the sound source and the receiver move relatively, and considering that the sound wave emitted by the sound source may directly reach the receiver or may reach the receiver after being reflected, the image sound source of the sound source is configured to simulate the sound wave emitted by the sound source and reaching the receiver after being reflected, and the image sound source of the sound source is considered as an individual that moves independently. The attenuation parameter of the image sound source can reflect the intensity of the sound wave emitted by the image sound source when the sound wave reaches the receiver, and the delay duration of the image sound source is the duration for the sound wave emitted by the image sound source to reach the receiver. Therefore, the attenuation parameters of the at least two image sound sources and the delay durations of the at least two image sound sources are used in combination with the first sound wave directly reaching the receiver after being emitted by the sound source, the second sound wave directly reaching the receiver after being emitted by each image sound source is simulated, and then the second sound waves corresponding to the at least two image sound sources are superposed, to obtain a sound wave after reverberation, so that the sound wave after reverberation can simulate a result that the receiver receives the second sound waves emitted by the at least two image sound sources, to simulate a reverberation effect after all sound waves emitted by the sound source reach the receiver after being reflected. The foregoing process of obtaining the target sound wave by using the attenuation parameters and the delay durations of the image sound sources implements a sound wave reverberation method. This sound wave reverberation method can be applicable to a situation where a sound source and a receiver move relatively. Even in the situation where the sound source and the receiver move relatively, a sound wave after reverberation can contain less noise, improving quality of the sound wave after reverberation and a reverberation effect.

In one or more embodiments of this disclosure, some sound waves emitted by the sound source are directly received by the receiver without reflection, and some sound waves emitted by the sound source are reflected for one or more times and then received by the receiver. The at least two image sound sources of the sound source are determined, so that each image sound source can simulate the sound wave emitted by the sound source and received by the receiver after reflection. In this way, a process in which the sound wave emitted by the sound source is received by the receiver is equivalent to a process in which the sound source and the at least two image sound sources emit sound waves to the receiver, the at least two image sound sources are individuals that move independently, and the sound wave emitted by each image sound source to the receiver can be disassembled into two parts, namely, a linear time-invariant part and a time-variant part. As the sound source moves, a position of the image sound source also changes, and thus, a distance between the image sound source and the receiver changes, which affects the delay duration of the image sound source and further affects the impulse response of the image sound source, and in other words, affects the time-variant part of the sound wave emitted by the image sound source to the receiver, so that the sound wave emitted by each image sound source to the receiver can be applicable to a situation where a sound source moves. In addition, the at least two image sound sources are individuals that move independently, and the sound wave emitted by each image sound source to the receiver can be obtained in the foregoing expression mode for the linear time-invariant part and the time-variant part. Moreover, a superposition principle is adopted to superpose the sound waves emitted by the at least two image sound sources and received by the receiver such that the obtained target sound wave can represent the sound wave received by the receiver and simulate a reverberation effect for a sound wave in a real scenario. The reverberation effect is equivalent to superposition of sound waves having different delays, thereby improving accuracy of the target sound wave.

Based on the non-limiting example of FIG. 2, in one or more embodiments of this disclosure, considering continuity of sound waves emitted by a sound source, sound waves of each image sound source at at least two sampling moments are sampled in a mode of sound wave discretization, thereby obtaining a reverberated sound wave received by the receiver at the at least two sampling moments. For a specific process, reference is made to the following embodiment.

FIG. 6 is a flowchart of a sound wave reverberation method according to an embodiment of this disclosure. The method is performed by the computer device. As shown in FIG. 6, the method includes the following operations.

601: The computer device obtains attenuation parameters of each image sound source at a plurality of first sampling moments and delay durations of each image sound source at the first sampling moments, the image sound sources being configured to simulate a sound wave that is emitted by the sound source and reaches the receiver after being reflected, the attenuation parameters indicating intensity of a sound wave emitted by the image sound source and received by the receiver, and the delay duration being a duration for the sound wave emitted by the image sound source to reach the receiver.

In one or more embodiments of this disclosure, considering continuity of sound waves emitted by the sound source, the sound waves emitted by the image sound source to the receiver are equivalent to the sound waves that are received by the receiver after some sound waves emitted by the sound wave are reflected, and the sound waves emitted by the image sound source to the receiver are also continuous. Therefore, for each image sound source corresponding to the sound source, attenuation parameters of each image sound source at the first sampling moments and delay durations of each image sound source at the first sampling moments are determined in a discrete mode, so that the sound waves received by the receiver at the first sampling moments can be determined subsequently.

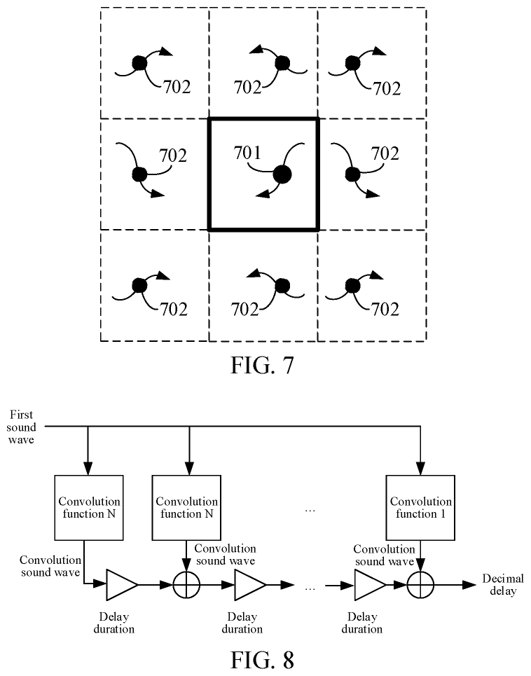

In one or more embodiments of this disclosure, because a position of the sound source may change with time, a position of the image sound source may change with time, and a distance between the image sound source and the receiver changes due to a change of the position of the image sound source. In addition, the distance between the image sound source and the receiver is related to the attenuation parameter of the image sound source. Therefore, the attenuation parameters of the image sound source at different moments may change. Similarly, the distance between the image sound source and the receiver is related to the delay duration of the image sound source. Therefore, the delay durations of the image sound source at different moments may change. As shown in FIG. 7, FIG. 7 includes a sound source 701 and seven image sound sources 702. Arrows are used for representing motion trajectories. The sound source moves along the motion trajectories. A position of the sound source 701 varies with time. Positions of the seven image sound sources 702 also vary with time. Therefore, delay durations of each image sound source 702 at different moments may vary.

In the plurality of first sampling moments, moments represented by different first sampling moments are different, and interval durations between every two neighboring first sampling moments are the same or different.

In an implementation example, the plurality of first sampling moments are obtained based on a first sampling rate, and the first sampling rate indicates a number of sampling times per unit time.

The unit time can be any time. For example, the unit time is one second or one minute.

In one or more embodiments of this disclosure, the first sampling rate can reflect a number of sampling times per unit time. Based on the first sampling rate, a first sampling moment of the number of sampling times is obtained within a unit sampling time, thereby obtaining the plurality of first sampling moments.

For example, the first sampling rate is 16000 Hz, and the first sampling rate indicates that the number of sampling times per unit time is 16000, and 16000 first sampling moments can be obtained from the unit time. For example, the unit time is 1 second, a 1^{st} first sampling moment is 1/16000 second, a 2^{nd} first sampling moment is 2/16000 second, and so on.

Operation 601 is similar to operation 201 above. Details are not described herein again.

602: The computer device determines the impulse response of each image sound source at the first sampling moment based on the pulse function and the delay duration of each image sound source at the first sampling moment.

In an implementation example, operation 602 includes: invoking, for any image sound source and any first sampling moment, the pulse function to calculate the target duration and the delay duration of the image sound source at the first sampling moment, to obtain the impulse response of the image sound source at the first sampling moment, the target duration being a duration taken to reach the receiver by the sound wave that is emitted by the sound source and is not reflected.

In one or more embodiments of this disclosure, the pulse function is invoked to calculate the target duration and the delay duration of the image sound source at the first sampling moment to obtain the impulse response of the image sound source at the first sampling moment, so as to reflect a delay time of the sound wave emitted by the image sound source and received by the receiver, compared with the sound wave emitted by the sound source and received by the receiver without being reflected, thereby determining an impact of the sound wave emitted by the image sound source on the receiver, and rendering a subsequent reverberation effect.

Operation 602 is similar to operation 202 or operation 304 above. Details are not described herein again.

603: The computer device convolves, for each image sound source and each first sampling moment, the first sound wave, the attenuation parameter of the image sound source at the first sampling moment, and the impulse response of the image sound source at the first sampling moment to obtain the second sound wave of the image sound source at the first sampling moment, the first sound wave being a sound wave emitted by the sound source and received by the receiver, and the second sound wave being a sound wave emitted by the image sound source and received by the receiver.

In one or more embodiments of this disclosure, for any image sound source, the attenuation parameters of the image sound source at a plurality of first sampling moments and the impulse responses of the image sound source at the plurality of first sampling moments have been obtained. A quantity of the attenuation parameters of the image sound source is the same as a quantity of the impulse responses of the image sound source. For the attenuation parameter and the impulse response of the image sound source at any first sampling moment, the first sound wave and the attenuation parameter and the impulse response of the image sound source at the first sampling moment are convolved, to obtain the second sound wave of the image sound source at the first sampling moment. In the foregoing mode, the second sound waves of the image sound source at the plurality of first sampling moments can be obtained. To be specific, at least two second sound waves of the image sound source are obtained.

For example, for any image sound source, the first sound wave, the attenuation parameter of the image sound source at the 1^{st} first sampling moment, and the impulse response of the image sound source at the 1^{st} first sampling moment are convolved, to obtain the second sound wave of the image sound source at the 1^{st} first sampling moment. The first sound wave, the attenuation parameter of the image sound source at the 2^{nd} first sampling moment, and the impulse response of the image sound source at the 2^{nd} first sampling moment are convolved, to obtain the second sound wave of the image sound source at the 2^{nd} first sampling moment. By analogy, based on the attenuation parameter and the impulse response of the image sound source at each first sampling moment, the second sound wave of the image sound source at each first sampling moment can be obtained.

Operation 602 is similar to operation 203 or operation 305 above. Details are not described herein again.

604: The computer device superposes at least two second sound waves of at least two image sound sources at the same first sampling moment to obtain target sound waves at a plurality of first sampling moments.

In some examples, components of the second sound waves of the image sound sources at a same first sampling moment are superposed to obtain a superposed component of the target sound wave at the same first sampling moment.

In one or more embodiments of this disclosure, the second sound waves of the at least two image sound sources at the same first sampling moment are sound waves emitted by the at least two image sound sources and received by the receiver at the same moment. The at least two second sound waves of the at least two image sound sources at the same first sampling moment are superposed, so that the obtained target sound waves are equivalent to sound waves received by the receiver in a real scenario, and a reverberated sound wave received by the receiver in the real scenario is simulated, thereby improving accuracy of the obtained target sound waves at the plurality of first sampling moments.

In an implementation example, after the target sound waves at the plurality of first sampling moments are obtained, the method further includes: generating a target sound file based on the target sound waves at the plurality of first sampling moments, a duration of the target sound file being an interval duration between the first sampling moment and the last first sampling moment; and playing the target sound file.

In one or more embodiments of this disclosure, the target sound waves at the plurality of first sampling moments are equivalent to the sound waves received by the receiver at the plurality of first sampling moments, i.e., sound waves acquired by the receiver at the plurality of first sampling moments. After the target sound file is generated based on the target sound waves at the plurality of first sampling moments, the target sound file can be played, so as to implement a sound acquisition and playback process. In this way, accuracy of sound playback can be improved.

In one or more embodiments of this disclosure, considering continuity of sound waves emitted by the sound source, the sound waves emitted by the image sound source to the receiver are equivalent to the sound waves that are received by the receiver after some sound waves emitted by the sound wave are reflected, and the sound waves emitted by the image sound source to the receiver are also continuous. Therefore, the attenuation parameters and the delay durations of the at least two image sound sources at the plurality of first sampling moments are determined in a discrete mode, so that the sound waves received by the receiver at the plurality of first sampling moments can be determined. In this way, continuous sound waves do not need to be processed in real time, thereby reducing a calculation amount. In addition, continuous sound waves can be emitted based on the target sound waves at the plurality of first sampling moments, thereby improving accuracy of the obtained target sound waves.

Based on the non-limiting example in FIG. 6, the at least two image sound sources include a first image sound source and a second image sound source, a distance between the first image sound source and the sound source is a second distance, a distance between the second image sound source and the sound source is a third distance, and the second distance is less than the third distance; and then the process of obtaining the attenuation parameters and the delay durations of the at least two image sound sources at the plurality of first sampling moments includes the following operations 1 to 5.

Operation 1: The computer device obtains the attenuation parameters of the first image sound source at the plurality of first sampling moments based on a first sampling rate, the first sampling rate indicating a number of sampling times per unit time.

In one or more embodiments of this disclosure, considering, in a case that a sound source changes with time, that an attenuation parameter of an image sound source having a small distance from the sound source changes non-linearly with time while an attenuation parameter of an image sound source having a large distance from the sound source changes linearly with time, the at least two image sound sources are divided into two types based on the distance between the image sound source and the sound source, namely, one type being a first image sound source and the other type being a second image sound source, so as to obtain attenuation parameters of different image sound sources in different modes.

The number of sampling times is a quantity of sampling moments obtained per unit time. The first sampling rate can be any sampling rate. For example, the first sampling rate is a preset sampling rate. For example, the first sampling rate is 16 KHz, and the first sampling rate indicates that the number of sampling times per unit time is 16000. The plurality of first sampling moments can be sampling moments in a unit time, or may be sampling moments in at least two unit times. For example, the first sampling rate is 16 KHz, the unit time is 1 second, and a quantity of the plurality of first sampling moments is 32000, and the at least two sampling moments are obtained through sampling in 2 seconds based on the first sampling rate.

In one or more embodiments of this disclosure, a plurality of first sampling moments can be determined based on the first sampling rate, and then the attenuation parameter of the first image sound source at each first sampling moment is obtained.

In an implementation example, operation 1 includes: obtaining positions of the sound source at the plurality of first sampling moments from a motion trajectory of the sound source based on the first sampling rate; determining a position of the first image sound source at each first sampling moment based on the position of the sound source at each first sampling moment; and obtaining the attenuation parameter of the first image sound source at each first sampling moment based on the position of the first image sound source at each first sampling moment and a position of a receiver.

In one or more embodiments of this disclosure, considering that the attenuation parameter of the first image sound source changes non-linearly with time, the attenuation parameter of the first image sound source at each first sampling moment is determined based on the first sampling rate, so as to improve accuracy of an obtained attenuation parameter.

In one or more embodiments of this disclosure, the sound source moves along the motion trajectory. A position change of the sound source may cause a position change of the image sound source. The position change of the image sound source may cause a change in a distance between the image sound source and the receiver. Moreover, the distance between the image sound source and the receiver is related to the attenuation parameter of the image sound source. Therefore, the positions of the sound source at the plurality of first sampling moments are obtained based on the first sampling rate, then, a position of the first image sound source at each first sampling moment is obtained, and the attenuation parameter of the first image sound source at each first sampling moment is obtained based on the position of the first image sound source at each first sampling moment and the position of the receiver, so that a sound source motion situation can be considered in the process of determining the attenuation parameter of the first image sound source, and then the impact of the sound source motion on the image sound source is considered, improving accuracy of the attenuation parameter of the first image sound source.

In some embodiments, the motion trajectory of the sound source is any motion trajectory set for the sound source, or the motion trajectory of the sound source is obtained by tracking the sound source.

In some embodiments, the process of determining the attenuation parameter of the first image sound source at each first sampling moment includes: determining a distance between the first image sound source and the receiver at the first sampling moment based on the position of the first image sound source at any first sampling moment and the position of the receiver; obtaining the absorption rate corresponding to the first image sound source; and determining the attenuation parameter of the first image sound source at the first sampling moment based on the distance between the receiver and the first image sound source at the first sampling moment and the absorption rate corresponding to the image sound source.

The foregoing process of determining the attenuation parameter of the first image sound source at each first sampling moment is similar to the foregoing operations 301 and 302. Details are not described herein again.

In an implementation example, a process of determining the first image sound source and the second image sound source includes: determining a distance between each of the at least two image sound sources and the sound source; determining, as the first image sound source, an image sound source having a distance from the sound source is less than a threshold; and determining, as the second image sound source, an image sound source in the at least two image sound sources other than the first image sound source. The threshold is any value.

In another possible implementation, a process of determining a first image sound source and a second image sound source includes: sorting at least two image sound sources in an ascending order of distances based on a distance between each of the at least two image sound sources and a sound source; determining the top 8 image sound sources as the first image sound source; and determining, as the second image sound source, an image sound source in the at least two image sound sources other than the first image sound source.

Operation 2: The computer device obtains the attenuation parameters of the second image sound source at the plurality of second sampling moments based on a second sampling rate, the second sampling rate indicating the number of sampling times per unit time, and the first sampling rate being higher than the second sampling rate.

The second sampling rate is any sampling rate lower than the first sampling rate. For example, the second sampling rate is 5 Hz. To be specific, a number of sampling times per unit time is 5. The plurality of second sampling moments can be sampling moments in a unit time, or may be sampling moments in at least two unit times. For example, the second sampling rate is 5 Hz, the unit time is 1 second, and a quantity of the plurality of second sampling moments is 10, and the plurality of second sampling moments are obtained through sampling in 2 seconds based on the second sampling rate.

In one or more embodiments of this disclosure, a plurality of second sampling moments can be determined based on the second sampling rate, and then the attenuation parameter of the second image sound source at each second sampling moment is obtained.

In an implementation example, operation 1 includes: obtaining positions of the sound source at the plurality of second sampling moments from a motion trajectory of the sound source based on the second sampling rate; determining a position of the second image sound source at each second sampling moment based on the position of the sound source at each second sampling moment; and obtaining the attenuation parameter of the second image sound source at each second sampling moment based on the position of the second image sound source at each second sampling moment and the position of the receiver.

In one or more embodiments of this disclosure, considering that the attenuation parameter of the second image sound source changes non-linearly with time, the attenuation parameter of the second image sound source at each second sampling moment is determined based on the second sampling rate, so as to improve accuracy of an obtained attenuation parameter.

In one or more embodiments of this disclosure, the sound source moves along the motion trajectory. A position change of the sound source may cause a position change of the image sound source. The position change of the image sound source may cause a change in a distance between the image sound source and the receiver. Moreover, the distance between the image sound source and the receiver is related to the attenuation parameter of the image sound source. Therefore, the positions of the sound source at the plurality of second sampling moments are obtained based on the second sampling rate, then, a position of the second image sound source at each second sampling moment is obtained, and the attenuation parameter of the second image sound source at each second sampling moment is obtained based on the position of the second image sound source at each second sampling moment and the position of the receiver, so that a sound source motion situation can be considered in the process of determining the attenuation parameter of the second image sound source, and then the impact of the sound source motion on the image sound source is considered, improving accuracy of the attenuation parameter of the second image sound source.

In some embodiments, the process of determining the attenuation parameter of the second image sound source at each second sampling moment includes: determining a distance between the second image sound source and the receiver at the second sampling moment based on the position of the second image sound source at any second sampling moment and the position of the receiver; obtaining the absorption rate corresponding to the second image sound source; and determining the attenuation parameter of the second image sound source at the second sampling moment based on the distance between the receiver and the second image sound source at the second sampling moment and the absorption rate corresponding to the image sound source.

The foregoing process of determining the attenuation parameter of the second image sound source at each second sampling moment is similar to the foregoing operations 301 and 302. Details are not described herein again.

In some embodiments, a process of obtaining the second sampling rate includes: obtaining a motion frequency of the sound source based on the motion trajectory of the sound source; and determining the second sampling rate based on the motion frequency of the sound source.

The motion frequency of the sound source can reflect the position change of the sound source in a unit time. The second sampling rate is a preset multiple of the motion frequency of the sound source. To be specific, a product of the motion frequency of the sound source and the preset multiple is determined as the second sampling rate.

In one or more embodiments of this disclosure, compared with the first sampling rate, the second sampling rate is a low sampling rate. The motion frequency of the sound source is determined based on the motion trajectory, and then the second sampling rate is determined, such that the second sampling rate may be as small as possible, so that the attenuation parameter obtained based on the second sampling rate is as small as possible, to reduce a calculation amount and improve the accuracy of an obtained attenuation parameter.

In some embodiments, a process of obtaining the motion frequency of the sound source includes: determining a speed of the sound source at each time point based on the motion trajectory of the sound source; performing fast Fourier transform on the speed of the sound source at each time point to obtain a speed spectrum; and determining a maximum frequency in the speed spectrum as a speed frequency of the sound source.

In one or more embodiments of this disclosure, because the motion trajectory of the sound source can reflect a position of the sound source at each time point, a speed of the sound source at each time point may be obtained by performing derivation on the position of the sound source at each time point.

An example in which a speed spectrum is obtained is used for descriptions above. In another embodiment, derivation is performed on the speed of the sound source at each time point to obtain an acceleration of the sound source at each time point. Fast Fourier transform is performed on the acceleration of the sound source at each time point to obtain an acceleration spectrum. A maximum frequency in the acceleration spectrum is determined as a speed frequency of the sound source.

Operation 3: The computer device obtains delay durations of at least two image sound sources at the second sampling moments based on the second sampling rate.

In one or more embodiments of this disclosure, the plurality of second sampling moments can be determined based on the second sampling rate, thereby obtaining a delay duration of each image sound source at each second sampling moment.

In an implementation example, operation 3 includes: obtaining positions of the sound source at the plurality of second sampling moments from a motion trajectory of the sound source based on the second sampling rate; determining positions of the at least two image sound sources at each second sampling moment based on the position of the sound source at each second sampling moment; and obtaining the delay durations of the at least two image sound sources at each second sampling moment based on the positions of the at least two image sound sources at each second sampling moment and the position of the receiver.

In one or more embodiments of this disclosure, considering that a delay duration of each image sound source linearly changes with time, the delay duration of each image sound source at each second sampling moment is determined based on the second sampling rate to improve accuracy of an obtained delay duration.

In one or more embodiments of this disclosure, the sound source moves along the motion trajectory. A position change of the sound source causes a position change of the image sound source, and a distance between the image sound source and the receiver is related to a delay duration of the image sound source. Therefore, the positions of the sound source at the plurality of second sampling moments are obtained based on the second sampling rate, then, a position of each image sound source at each second sampling moment is obtained, and the delay duration of each image sound source at each second sampling moment is obtained based on the position of each image sound source at each second sampling moment and the position of the receiver, so that a sound source motion situation can be considered in a process of determining the delay duration of each image sound source, and then the impact of the sound source motion on the image sound source is considered, improving accuracy of the delay duration of the image sound source.

In some embodiments, a process of obtaining the delay durations of the at least two image sound sources at each second sampling moment includes: determining, for any one image sound source and any one second sampling moment, a distance between the image sound source and the receiver at the second sampling moment based on the position of the image sound source at the second sampling moment and the position of the receiver; and determining a ratio of the distance between the image sound source and the receiver at the second sampling moment to the sound wave transmission speed as the delay duration of the image sound source at the sampling moment.

The process of determining the delay duration of the image sound source at each second sampling moment is similar to operation 303. Details are not described herein again.

In an implementation example, the process of determining the delay duration of the image sound source at each second sampling moment includes: invoking, for any one image sound source, a pulse function to calculate a first sound wave at the second sampling moment and the delay duration of the image sound source at the second sampling moment, to obtain an impulse response of the image sound source at the second sampling moment, the first sound wave at the second sampling moment being a sound wave emitted by the sound source without reflection and received by the receiver at the second sampling moment.

In one or more embodiments of this disclosure, some sound waves emitted by the sound source directly reach the receiver without reflection and then are received by the receiver, i.e., the first sound waves, and the sound wave emitted by the image sound source and received by the receiver is equivalent to the sound wave emitted by the sound source and reaching the receiver after being reflected. Therefore, the impulse response of the image sound source is obtained with reference to the first sound wave and the delay duration of the image sound source, so as to reflect a propagation situation of the sound wave emitted by the image sound source to the receiver, thereby improving accuracy of the impulse response of the image sound source.

In an implementation example, the pulse function includes a plurality of convolution functions, and the process of determining the delay duration of the image sound source at each second sampling moment includes: invoking each convolution function in the pulse function to separately perform convolution on the first sound wave at the second sampling moment to obtain a plurality of convolution sound waves at the second sampling moment; and invoking the pulse function to performed fuse on the plurality of convolution sound waves at the second sampling moment and the delay duration of the image sound source at the second sampling moment to obtain the impulse response of the image sound source at the second sampling moment.

The plurality of convolution functions are in one-to-one correspondence with the plurality of convolution sound waves. Different convolution functions include different parameters, and the different convolution functions correspond to different convolution sound waves.

In one or more embodiments of this disclosure, computation is performed on the first sound wave and the delay duration in modes of convolution and fusion through the pulse function, such that the obtained impulse response can reflect a situation where the sound wave emitted by the image sound source to the receiver propagates, thereby improving accuracy of the impulse response.

In some embodiments, the impulse response of the image sound source satisfies the following relationship:

Λᵢ(n)= [symbol] (n)^{T}Δ(n)

[symbol]

(n)=[y₀(n),y₁(n), . . . ,y_{N}(n)]^{T}

Δ(n)=[Dᵢ(n),Dᵢ²(n), . . . ,Dᵢ^{N}(n)]

yₖ(n)=s(n)⊗cₖ(n)

n is used for representing any one second sampling moment, Λᵢ(n) is used for representing an impulse response of an i^{th} image sound sources at a second sampling moment n, [symbol] (n) is used for representing a vector formed by a plurality of convolution sound waves at the second sampling moment n, Δ(n) is used for representing a vector formed by a delay duration of an image sound source at the second sampling moment n, T is used for representing transposition of a matrix, y₀(n) is used for representing a 0^{th} convolution sound wave at the second sampling moment n, y₁(n) is used for representing a 1^{st} convolution sound wave at the second sampling moment n, y_{N}(n) is used for representing an N^{th} convolution sound wave at the second sampling moment n, N is an integer greater than 1, yₖ(n) is used for representing a k^{th} convolution sound wave at the second sampling moment n, k is an integer not less than 0 and not greater than N, s(n) is used for representing a first sound wave at the second sampling moment n, cₖ(n) is used for representing the k^{th} convolution function in the pulse function, k is an integer not greater than N, and ⊗ is used for representing convolution.

In some embodiments, the pulse function can be included in a Farrow (a filter) architecture. The first sound wave and the delay duration of the image sound source are inputted into the Farrow architecture to perform calculation. The Farrow architecture can perform calculation based on the pulse function and output the impulse response of the image sound source. For example, a structure of the Farrow architecture is as shown in FIG. 8.

In one or more embodiments of this disclosure, the delay duration of the image sound source at each second sampling moment is determined in a discrete digital calculation mode. For a continuous time dᵢ(t), dᵢ(n) at any second sampling moment n, dᵢ(n) is not an integer. dᵢ(n) includes an integer part and a decimal part. In a process of obtaining the impulse response of the image sound source at the second sampling moment, the integer part of dᵢ(n) is implemented by translating a sound wave along a time axis to obtain an integer delay. The decimal part of dᵢ(n) is implemented by using the Farrow architecture to obtain a decimal delay. The integer delay and the decimal delay are fused to obtain the impulse response of the image sound source at the second sampling moment.

Operation 4: The computer device performs upsampling on the attenuation parameters of the second image sound source at the second sampling moments to obtain the attenuation parameters of the second image sound source at the first sampling moments.

In one or more embodiments of this disclosure, considering that the attenuation parameter of the second image sound source linearly changes with time, the attenuation parameters of the second image sound source at the plurality of second sampling moments are obtained based on the second sampling rate lower than the first sampling rate, and then, the upsampling mode is used to obtain the attenuation parameters of the second image sound source at the plurality of first sampling moments, thereby reducing a calculation amount as much as possible and improving efficiency of obtaining the attenuation parameters.

In an implementation example, operation 4 includes: determining, for any one first sampling moment, two second sampling moments adjacent to the first sampling moment; and determining the attenuation parameter of the second image sound source at the first sampling moment in an interpolation mode based on the attenuation parameters of the second image sound source at the two second sampling moments.

In one or more embodiments of this disclosure, because the attenuation parameter of the second image sound source linearly changes with time, the attenuation parameters of the second image sound source at the plurality of first sampling moments are determined in an interpolation mode based on the attenuation parameters of the second image sound source at the plurality of second sampling moments, such that the attenuation parameters of the second image sound source at the plurality of first sampling moments may linearly change with time and thereby improving accuracy of determined attenuation parameters.

Operation 5. Perform upsampling on the delay durations of the at least two image sound sources at the second sampling moments to obtain delay durations of the at least two image sound sources at the first sampling moments.

In one or more embodiments of this disclosure, considering that the delay duration of the image sound source linearly changes with time, the delay durations of the image sound source at the plurality of second sampling moments are obtained based on the second sampling rate lower than the first sampling rate, and then, the upsampling mode is used to obtain the delay durations of the image sound source at the plurality of first sampling moments, thereby reducing a calculation amount as much as possible and improving efficiency of obtaining the delay durations.

Operation 5 is similar to operation 4 above. Details are not described herein again.

In one or more embodiments of this disclosure, considering, in a case that the sound source changes with time, that the attenuation parameter of the image sound source having a small distance to the sound source changes non-linearly with time while the attenuation parameter of the image sound source having a large distance to the sound source changes linearly with time, the at least two image sound sources are divided into two types based on the distance between the image sound source and the sound source, namely, one type being the first image sound source and the other type being the second image sound source, and the delay duration of each image sound source linearly changes with time. Therefore, the attenuation parameters of the first image sound source at the plurality of first sampling moments are obtained based on the first sampling rate, and the attenuation parameters of the second image sound source at the plurality of second sampling moments and the delay durations of each image sound source at the plurality of second sampling moments are obtained based on the second sampling rate lower than the first sampling rate, and then the upsampling mode is used to obtain the attenuation parameters of the second image sound source at the plurality of first sampling moments and the delay durations of the image sound source at the plurality of first sampling moments, thereby reducing a calculation amount as much as possible and improving efficiency of obtaining the attenuation parameters and the delay durations.

In one or more embodiments of this disclosure, an example in which the sound source moves is used as an example, and the attenuation parameter and the delay duration of each image sound source are obtained by using the motion trajectory of the sound source. In another embodiment, the sound source is kept stationary, and the receiver moves. Then, in the foregoing mode, based on the motion trajectory of the receiver and with reference to the first sampling rate or the second sampling rate, positions of the receiver at the plurality of first sampling moments or positions of the receiver at the plurality of second sampling moments are determined, and then, the attenuation parameter and the delay duration of each image sound source are obtained with reference to the positions of the image sound sources at the plurality of first sampling moments or the positions of the image sound sources at the plurality of second sampling moments. In addition, the two examples may be combined. To be specific, both the sound source and the receiver move. In this case, obtaining the attenuation parameter and the delay duration of each image sound source is similar to the foregoing description. Details are not described herein again.

In the at least two image sound sources involved in the foregoing embodiment, the attenuation parameter of the first image sound source changes non-linearly with time, the attenuation parameter of the second image sound source linearly changes with time, and the delay duration of each image sound source linearly changes with time. Based on the foregoing embodiment, the following embodiment describes in further detail the non-linear change of the attenuation parameter of the first image sound source with time, the linear change of the attenuation parameter of the second image sound source with time, and the linear change of the delay duration of each image sound source linearly with time.

For any continuous motion, a displacement p(t), a speed v(t), and an acceleration a(t) satisfy the following relationships:

$$υ ( t ) = {υ}_{0} + {\int }_{0}^{t} a ( τ ) d τ$$

$$p ( t ) = {υ}_{0} t + {\int }_{0}^{t} {\int }_{0}^{{t}^{′}} a ( τ ) d τ {dt}^{′}$$

τ is used for representing an independent variable of time, a value range of τ is [0, t], a(τ) is used for representing an acceleration about the independent variable τ, v₀ is used for representing a starting speed for the motion, dτ is used for representing a derivative of the independent variable τ, t is used for representing any one moment in a motion process, v(t) is used for representing a speed at the moment t, t′ is used for representing another moment in the motion process, dt′ is used for representing a derivative of the moment t′, and p(t) is used for representing a displacement at the moment t.

For the relationships satisfied by the displacement p(t), the speed v(t), and the acceleration a(t) for motion, the relationship satisfied by the displacement p(t), the speed v(t), and the acceleration a(t) is converted into expressions about a motion frequency, to obtain the following relationships:

$$\text{?} ( a ( t ) ) = 𝔸 ( ω )$$

$$\text{?} ( \int \int a ( τ ) d τ ) = - \frac{𝔸 ( ω )}{{ω}^{2}}$$

a(t) is used for representing an acceleration for motion, w is used for representing a motion frequency, [symbol] (a(t)) is a motion speed represented by using the motion frequency and is also used for representing Fourier transform of the acceleration a(t), [symbol] (⋅) is a function about the motion frequency, [symbol] (w) is used for representing a motion speed represented by using the motion frequency, a(T) is used for representing an acceleration about the independent variable τ, dτ is used for representing a derivative of the independent variable τ, and [symbol] (∫∫a(τ)dτ) is a motion displacement represented by using the motion frequency.

The foregoing relationship satisfied by the displacement p(t), the speed v(t), and the acceleration a(t) is converted into the expressions about the motion frequency, and on this basis, the following relationships are obtained:

$$\begin{matrix}p ( ω ) = \text{?} ( υ ( t ) ) + \text{?} ( {\int }_{0}^{t} {\int }_{0}^{{t}^{′}} a ( τ ) d τ {e}^{- ω {t}^{′}} {dt}^{′} ) \\ = \int {υ}_{0} t {e}^{- j ω {t}^{′}} dt \int {\int }_{0}^{t} {\int }_{0}^{{t}^{′}} a ( τ ) d τ {e}^{- ω {t}^{′}} {dt}^{′} \\ = j {υ}_{0} \frac{δ ( ω )}{ω} - \frac{𝔸 ( ω )}{{ω}^{2}}\end{matrix}$$

p(w) is used for representing a motion displacement represented by using a motion frequency, w is used for representing the motion frequency, v(t) is used for representing a motion speed, [symbol] (v(t)) is used for representing a displacement related to the speed v(t),

$$\text{?} ( {\int }_{0}^{t} {\int }_{0}^{{t}^{′}} a ( τ ) d τ {e}^{- ω {t}^{′}} {dt}^{′} )$$

is used for representing a displacement related to the acceleration, τ is used for representing an independent variable of time, a value range of τ is [0, t], a(τ) is used for representing an acceleration about the independent variable τ, dτ is used for representing a derivative of the independent variable τ, t is used for representing any one moment in a motion process, t′ is used for representing another moment in the motion process, dt′ is used for representing a derivative of the moment t′, e is used for representing a natural constant, v₀ is used for representing a starting speed for motion, j is used for representing an imaginary unit, δ(w) is used for representing a function about the motion frequency w, and [symbol] (w) is used for representing a motion speed represented by using the motion frequency.

Based on the foregoing relationships, a bandwidth of a motion displacement depends on a bandwidth of a motion acceleration, namely, a change rate of the motion acceleration, i.e., a motion frequency, and is rapidly attenuated by the square of the motion frequency. Human body motion has an acceleration change rate less than 5 Hz and a displacement bandwidth less than 2 Hz, and even a person from a specific group shakes with only 4-6 Hz. Therefore, a high sampling rate does not need to be used to sample a position of a sound source from a motion trajectory of the sound source.

Further, Taylor series expansion is performed on the attenuation parameter of the image sound source. An i^{th} image sound source is used as an example, and the attenuation parameter of the i^{th} image sound source satisfies the following relationships:

$${A}_{i} ( t ) ∼ \frac{1}{{‖ {p}_{i} ( t ) - {p}_{r} ‖}_{2}}$$

$${A}_{i} ( t ) ∼ \frac{1}{{x}_{i}} = \frac{1}{{x}_{p}} \frac{1}{{x}_{i}^{2}} ( {x}_{i} - {x}_{p} ) + \frac{1}{{x}_{i}^{3}} {( {x}_{i} - {x}_{p} )}^{2} + …$$

Aᵢ(t) is used for representing the attenuation parameter of the i^{th} image sound source at a t^{th} moment, pᵢ(t) is used for representing positions of i image sound sources at the t^{th} moment, pᵣ is used for representing a position of a receiver, ∥⋅∥₂ is used for representing a two-norm, xᵢ is equivalent to ∥pᵢ(t)−pᵣ∥₂, and xₚ is used for representing a position of a mirror room in which the i^{th} image sound source is located, which is obtained by performing Taylor series expansion on the attenuation parameter Aᵢ(t) of the i^{th} image sound source at the t^{th} moment at the position of the mirror room in which the i^{th} image sound source is located, and can also represent a distance between the i^{th} image sound source and a sound source.

Based on the relationship satisfied by the attenuation parameter of the i^{th} image sound source, in a case that a mirror distance xₚ is greater than 1 meter, a higher-order term in the relationship for Taylor series expansion rapidly attenuates with an increase in the mirror distance xₚ, and the attenuation parameter of the i^{th} image sound source is related to the position of the i^{th} image sound source, and a bandwidth of the motion trajectory of the image sound source can be ignored. In a case that the mirror distance xₚ is less than 1 meter, the higher-order term in the relationship for Taylor series expansion exists, and the bandwidth of the motion trajectory of the image sound source is high. Therefore, for at least two image sound sources corresponding to a sound source, it can be determined that the attenuation parameter of the first image sound source changes non-linearly with time and the attenuation parameter of the second image sound source linearly changes with time. To be specific, it is determined that an attenuation parameter of a low-order image sound source changes non-linearly with time and an attenuation parameter of a high-order image sound source linearly changes with time. Therefore, both direct sound waves of the first image sound source and the sound source are obtained through a high sampling rate. A direct sound wave of a sound source refers to a sound wave emitted by the sound source and received by a receiver without reflection.

Taylor series expansion is performed on the delay duration of the image sound source. An i^{th} image sound source is used as an example, and the delay duration of the i^{th} image sound source satisfies the following relationships:

$${x}_{i} = \vert {p}_{i , x} - {p}_{r , x} \vert$$

$$f ( {x}_{i} ) = \sqrt{{x}_{i}^{2} + {y}_{i , 0}^{2} + {z}_{i , 0}^{2}}$$

$$f ( {x}_{i} ) = f ( {x}_{p} ) + {x}_{p} {f ( {x}_{p} )}^{- 1} ( {x}_{i} - {x}_{p} ) + ( {f ( {x}_{p} )}^{2} - {x}_{p}^{2} ) {f ( {x}_{p} )}^{- 3} {( {x}_{i} - {x}_{p} )}^{2} + ( 3 {x}_{p}^{2} - 1 ) / {f ( {x}_{p} )}^{- 5} {( {x}_{i} - {x}_{p} )}^{3} + …$$

xᵢ is used for representing a distance between the i^{th} image sound source and the receiver on an X axis, p_{i,x} is used for representing a position of the i^{th} image sound source on the X axis, pᵣ is used for representing a position of the receiver on the X axis, y_{i,0} is used for representing a distance between the i^{th} image sound source and the receiver on a Y axis, z_{i,0} is used for representing a distance between the i^{th} image sound source and the receiver on a Z axis, f(xᵢ) is used for representing a distance between the i^{th} image sound source and the receiver, xₚ represents a position of a mirror room, and f(xₚ) is used for representing a distance between an image sound source in a p^{th} mirror room and the receiver.

Based on the Taylor series expansion relationships for the delay duration of the i^{th} image sound source at the position of the mirror room where the i^{th} image sound source is located, a motion range of an image sound source is limited by a room where the sound source is located. To be specific, the motion range of the image sound source is a finite, small value, and f(xᵢ) rapidly attenuates with the increase of f(xₚ).

Based on the Taylor series expansion relationship for the delay duration of the i^{th} image sound source, the following relationship can be obtained:

[symbol]

(x²(t))= [symbol] (x(t))⊗ [symbol] (x(t))

x(t) is used for representing any one sound wave, [symbol] (x²(t)) is used for representing a bandwidth of a square of the sound wave x(t), and [symbol] (x(t)) is used for representing a bandwidth of the sound wave x(t). Therefore, based on the relationship, a square of a band-limited sound wave is twice a bandwidth of the sound wave. To be specific, a bandwidth of a quadratic term in the Taylor series is twice a bandwidth of a motion displacement.

Based on the foregoing inference, a motion space-time sampling reconstruction theory can be obtained. An upper limit of a bandwidth of a displacement during motion determines a sampling rate, in terms of time, for reconstructing a sound wave propagating to a receiver through air. Because if f(xₚ) increases after the Taylor series expansion, the high-order term in the Taylor series quickly attenuates with the increase of the Taylor series. For the high-order image sound source, only the part up to the quadratic term in the above Taylor series can be retained. Therefore, a bandwidth of a delay duration of a high-order image sound source is approximately twice a motion frequency of a sound source. Therefore, the delay duration of the high-order image sound source can be obtained by using a low sampling rate, i.e., twice the motion frequency. In this way, the attenuation parameters and the delay durations of the image sound source can be sampled at different sampling rates to reduce a calculation amount.

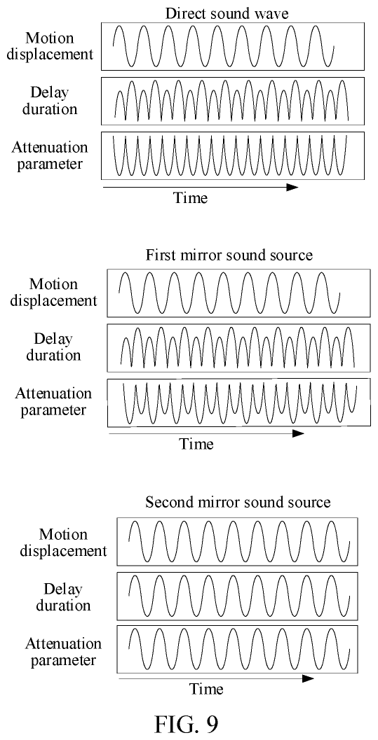

For example, for the sound source, the first image sound source, and the second image sound source, motion displacements, delay durations, and attenuation parameters of the sound sources are as shown in FIG. 9. It may be learned from FIG. 9 that the motion displacements of the sound source, the first image sound source, and the second image sound source are synchronized, and the delay durations and the attenuation parameters of the sound sources are unsynchronized with the motion displacements of the sound sources, reflecting that direct sound waves emitted by the sound source present nonlinear changes. The delay duration and the attenuation parameter of the first image sound source are unsynchronized with the motion displacement of the first image sound source, and the delay duration and the attenuation parameter of the second image sound source are synchronized with the motion displacement of the second image sound source.

In one or more embodiments of this disclosure, a complex sound field fluctuation equation is converted into a superposition of at least two image sound sources in a free field by using a Green's function. In addition, considering that a position of a sound source changes with time, a position of an image sound source changes with time. Then, a sound wave emitted by the image sound source and received by a receiver is disassembled into two parts, namely, a linear time-invariant part and a time-variant part, so that the sound wave reverberation solution provided in one or more embodiments of this disclosure can be applied to a scenario in which the position of the sound source changes and has a wide application range. For example, a user speaks while the user shakes its head, or the user speaks while walking. In these scenarios, based on the solution provided in one or more embodiments of this disclosure, an accurate sound wave after reverberation can be obtained.

The Green's function satisfies the following relationship:

$$g ( \vec{r} - {\vec{r}}^{′} , t - {t}^{′} ) = \frac{δ ( t - {t}^{′} - \frac{R}{c} )}{4 π R}$$

\vec{r} is used for representing a position of a receiver, \vec{r}′ is used for representing a position of a sound source, t′ is used for representing time when the sound source emits a sound wave, t is used for representing time when the receiver receives the sound wave, c is used for representing a sound wave transmission speed, R is used for representing a distance between the receiver and the sound source and is also equivalent to \vec{r}−\vec{r}′, and δ(⋅) is used for representing a pulse function.

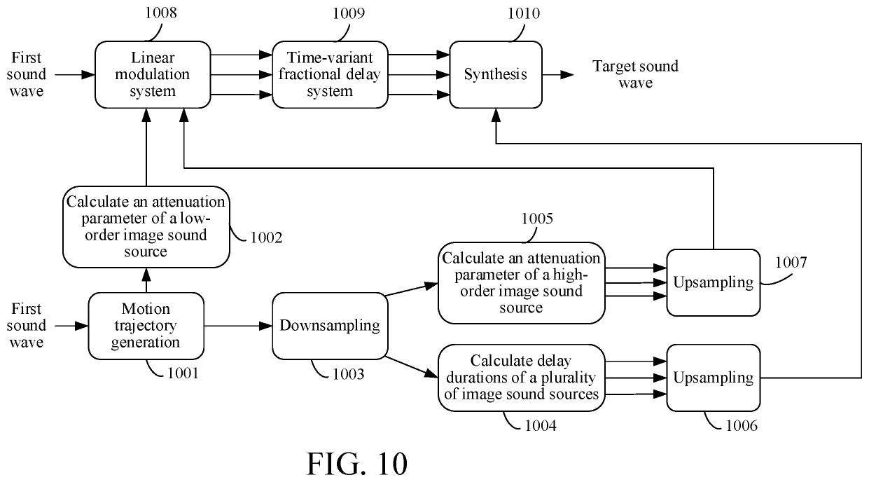

Based on the foregoing embodiments, this disclosure may further provide a flowchart of a sound wave reverberation method. As shown in FIG. 10, a first image sound source is referred to as a low-order image sound source and a second image sound source is referred to as a high-order image sound source. The method includes:

1001: Randomly generate a motion trajectory of a sound source.

1002: Obtain, for a low-order image sound source, positions of the sound source at a plurality of first sampling moments from the motion trajectory of the sound source based on a first sampling rate; determine a position of the low-order image sound source at each first sampling moment based on the position of the sound source at each first sampling moment; and determine, for each first sampling moment, a distance between the low-order image sound source and a receiver at the first sampling moment based on the position of the low-order image sound source at the first sampling moment and a position of the receiver, obtain an absorption rate corresponding to the low-order image sound source, and determine an attenuation parameter of the first image sound source at the first sampling moment based on the distance between the receiver and the low-order image sound source at the first sampling moment and the absorption rate corresponding to the image sound source.

1003: Obtain positions of the sound source at a plurality of second sampling moments from the motion trajectory at a second sampling rate; and determine, for each second sampling moment, a position of each image sound source at the second sampling moment based on the position of the sound source at the second sampling moment, to obtain the position of each image sound source at each second sampling moment.

1004: Determine, for each image sound source, a distance between the image sound source at the second sampling moment and the receiver based on the position of the image sound source at the second sampling moment and the position of the receiver, and determine a ratio of the distance between the image sound source at the second sampling moment and the receiver to a sound wave transmission speed as a delay duration of the image sound source at the sampling moment, to obtain a delay duration of each image sound source at each second sampling moment.

1005: Determine, for a high-order image sound source, a distance between the high-order image sound source and the receiver at the second sampling moment based on a position of the high-order image sound source at the second sampling moment and the position of the receiver, obtain an absorption rate corresponding to the high-order image sound source, and determine an attenuation parameter of the high-order image sound source at the second sampling moment based on the distance between the high-order image sound source and the receiver at the second sampling moment and the absorption rate corresponding to the image sound source.

1006: Perform upsampling on, for each image sound source, the delay durations of the image sound source at the plurality of second sampling moments in a parallel processing mode, to obtain delay durations of the image sound source at the plurality of first sampling moments.

1007: Perform upsampling on the attenuation parameters of the high-order image sound sources at the plurality of second sampling moments in a parallel processing mode, to obtain attenuation parameters of the high-order image sound sources at the plurality of first sampling moments.

1008: Process, for each first sampling moment and each image sound source, a first sound wave at the first sampling moment and the attenuation parameter of the image sound source at the first sampling moment by invoking a linear modulation system and in a parallel processing mode, and input an obtained processing result into a time-variant fractional delay system.

1009: Process, for each first sampling moment and each image sound source, the delay duration of the image sound source at the first sampling moment by invoking the time-variant fractional delay system and in a parallel processing mode based on a pulse function, to obtain an impulse response of the image sound source, and convolve the impulse response of the image sound source and a processing result corresponding to the image sound source, to a second sound wave of the image sound source at the first sampling moment.

1010: In a case that a second sound wave of each image sound source at each first sampling moment is obtained, superpose, for each first sampling moment, the second sound wave at the first sampling moment and the first sound wave, to obtain a target sound wave at the first sampling moment, and then obtain target sound waves at the plurality of first sampling moments, where the target sound wave is a sound wave after reverberation.

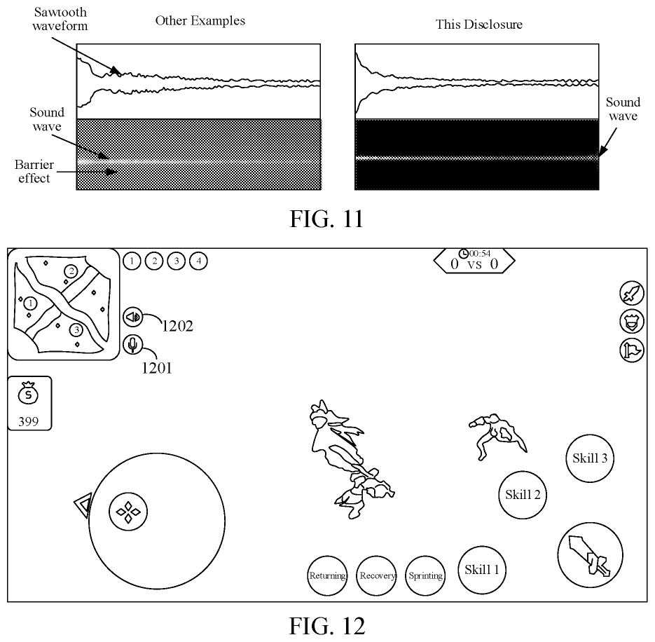

In one or more embodiments of this disclosure, the first sampling rate is 16 KHz, and the second sampling rate is 5 Hz. In a process of obtaining the target sound wave, calculation complexity is reduced from 1.44 G to 705 K, and is reduced by 2092 times. In addition, compared with other examples, as shown in FIG. 11, a sound wave after reverberation based on these other examples may have problems of phase discontinuity and sawtooth gain, and a barrier effect occurs. However, in this disclosure, the sound wave after reverberation has a continuous phase, and no sawtooth gain exists. The sound wave after reverberation obtained based on one or more embodiments of this disclosure has high quality. In addition, the solution provided in one or more embodiments of this disclosure may address a problem of poor robustness of a multi-channel end-to-end voice tracking algorithm, and complete reverberation rendering of a low-complexity mobile scenario.

In addition, in the other examples, a reverberation solution in a scenario in which a sound source and a receiver are relatively displaced is simulated by using a mirror reverberation solution, and a reverberation effect is poor, resulting in poor quality of a sound wave received by the receiver. However, the solution provided in one or more embodiments of this disclosure can be applicable to a situation in which the sound source and the receiver move relatively, avoiding a situation in which the sound wave after reverberation includes noise because the sound source and the receiver move relatively, improving quality of the obtained target sound wave, such that the sound wave after reverberation has a better and more realistic reverberation effect.

Based on the foregoing embodiment, the sound wave reverberation solution provided in one or more embodiments of this disclosure can be applied to a plurality of scenarios such as a game scenario or a model training scenario.

Using the game scenario as an example, embodiments of this disclosure provide a sound wave reverberation method. The method includes: A terminal runs a game application; the terminal participates in a virtual battle through the game application; in a process of the virtual battle, as shown in FIG. 12, in a case that a microphone identifier 1201 is turned on, the terminal acquires a speech emitted by a user through the microphone, and transmits the speech to a game server; and the game server uses the speech as a speech signal emitted by a sound source. For example, the speech emitted by the terminal lasts for 10 seconds, which is equivalent to that the sound source emits a 10-second speech signal. Using an example in which the sound wave is a speech signal, the first sound wave is a first speech signal, the second sound wave is a second speech signal, and the target sound wave is a target speech signal. According to the foregoing operations 1001 to 1010, target speech signals at a plurality of first sampling moments are obtained, and a target speech is generated based on the target speech signals at the plurality of first sampling moments. A duration of the target speech is the same as a duration of the speech acquired by the terminal, and the target speech is a speech obtained after reverberating the speech acquired by the terminal. The game server transmits the target speech to the terminal participating in the virtual battle, so that in a loudspeaker identifier 1202 is turned on, the terminal participating in the virtual battle automatically play the target speech through the loudspeaker, thereby implementing a solution of reverberating the speech emitted by the user in the game scenario.

In the model training scenario, using an example in which the sound wave is a speech signal, a speech can be acquired in real time by using the microphone. The acquired speech is equivalent to a dry sound. According to the foregoing operations 1001 to 1010, reverberation is performed on the acquired speech, to obtain target speech signals at the plurality of first sampling moments. The target speech signal is equivalent to a reverberated wet sound. A target speech is generated based on the target speech signals at the plurality of first sampling moments. A duration of the target speech is the same as a duration of the speech acquired by the terminal, and the target speech is a speech obtained after reverberating the speech acquired by the terminal. The target speech is configured as data for subsequently training a model, for example, a speech recognition model or a reverberation processing model.

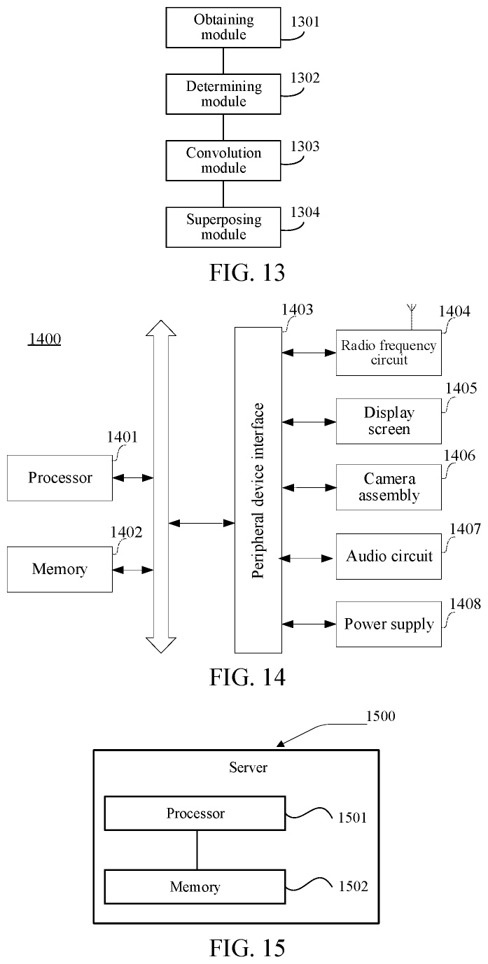

FIG. 13 is a schematic structural diagram of a sound wave reverberation apparatus according to an embodiment of this disclosure. As shown in FIG. 13, the apparatus includes:
an obtaining module 1301, configured to obtain attenuation parameters of at least two image sound sources corresponding to a sound source and delay duration of the at least two image sound sources, the image sound sources being configured to simulate a sound wave emitted by the sound source and reaching a receiver after being reflected, the attenuation parameters indicating intensity of a sound wave emitted by the image sound source and received by the receiver, and the delay duration being duration for the sound wave emitted by the image sound source to reach the receiver;
a determining module 1302, configured to determine an impulse response of each image sound source based on a pulse function and the delay duration of each image sound source;
a convolution module 1303, configured to convolve, for each image sound source, a first sound wave, the attenuation parameter of the image sound source, and the impulse response of the image sound source to obtain a second sound wave, the first sound wave being a sound wave emitted by the sound source and received by the receiver, and the second sound wave being a sound wave emitted by the image sound source and received by the receiver; and
a superposing module 1304, configured to superpose the obtained at least two second sound waves to obtain a target sound wave.

In an implementation example, the obtaining module 1301 is configured to obtain an absorption rate corresponding to the image sound source, the absorption rate indicating intensity of a sound wave emitted by the image sound source; and determine an attenuation parameter of the image sound source based on a first distance and the absorption rate, the first distance being a distance between the receiver and the image sound source.

In another possible implementation, the obtaining module 1301 is configured to determine a ratio of the absorption rate to the first distance as the attenuation parameter of the image sound source; or determine a product of the first distance and a target value, and determine a ratio of the absorption rate to the product as the attenuation parameter of the image sound source.

In another possible implementation, the obtaining module 1301 is configured to determine a ratio of the first distance to a sound wave transmission speed as the delay duration of the image sound source, the first distance being the distance between the receiver and the image sound source.

In another possible implementation, the determining module 1302 is configured to invoke the pulse function to calculate a target duration and the delay duration of the image sound source, to obtain an impulse response of the image sound source, the target duration being a duration taken to reach the receiver by the sound wave that is emitted by the sound source and is not reflected.

In another possible implementation, the determining module 1302 is configured to invoke the pulse function to calculate the first sound wave and the delay duration of each image sound source, to obtain the impulse response of each image sound source.

In another possible implementation, the convolution module 1303 is configured to determine, for each image sound source, a product of the first sound wave and the attenuation parameter of the image sound source; and convolve the product and the impulse response to obtain the second sound wave.

In another possible implementation, the superposing module 1304 is configured to superpose the first sound wave and the at least two second sound waves to obtain the target sound wave.

In another possible implementation, the obtaining module 1301 is configured to obtain attenuation parameters of each image sound source at a plurality of first sampling moments and delay durations of each image sound source at the plurality of first sampling moments;
the convolution module 1303 is configured to convolve, for each image sound source and each first sampling moment, the first sound wave, the attenuation parameter of the image sound source at the first sampling moment, and the impulse response of the image sound source at the first sampling moment to obtain a second sound wave of the image sound source at the first sampling moment, the impulse response of the image sound source at the first sampling moment being determined based on the pulse function and the delay duration of the image sound source at the first sampling moment; and
the superposing module 1304 is configured to superpose the second sound waves of the at least two image sound sources at the same first sampling moment to obtain the target sound waves at the plurality of first sampling moments.

In another possible implementation, the at least two image sound sources include a first image sound source and a second image sound source, a distance between the first image sound source and the sound source is a second distance, a distance between the second image sound source and the sound source is a third distance, and the second distance is less than the third distance; and the obtaining module 1301 is configured to obtain attenuation parameters of the first image sound source at the plurality of first sampling moments based on a first sampling rate, the first sampling rate indicating a number of sampling times per unit time; obtain attenuation parameters of the second image sound source at a plurality of second sampling moments based on a second sampling rate, the second sampling rate indicating the number of sampling times per unit time, and the first sampling rate being higher than the second sampling rate; obtain delay durations of each image sound source at the plurality of second sampling moments based on the second sampling rate; perform upsampling on the attenuation parameters of the second image sound source at the plurality of second sampling moments to obtain attenuation parameters of the second image sound source at the plurality of first sampling moments; and perform upsampling on the delay durations of each image sound source at the plurality of second sampling moments to obtain delay durations of each image sound source at the plurality of first sampling moments.

In another possible implementation, the obtaining module 1301 is configured to obtain positions of the sound source at the plurality of first sampling moments from a motion trajectory of the sound source based on the first sampling rate; determine a position of the first image sound source at each first sampling moment based on the position of the sound source at each first sampling moment; and obtain, for each image sound source, the delay duration of the image sound source at each second sampling moment based on the position of the image sound source at each second sampling moment and the position of the receiver.

In another possible implementation, the obtaining module 1301 is configured to obtain positions of the sound source at the plurality of second sampling moments from the motion trajectory of the sound source based on the second sampling rate; determine positions of the at least two image sound sources at each second sampling moment based on the position of the sound source at each second sampling moment; and obtain the delay durations of the at least two image sound sources at each second sampling moment based on the positions of the at least two image sound sources at each second sampling moment and the position of the receiver.

The sound wave reverberation apparatus provided in the foregoing embodiment is illustrated only with an example of division of the foregoing function modules. In practical applications, the foregoing functions may be allocated to and completed by different function modules according to requirements. In other words, the internal structure of the computer device is divided into different function modules to complete all or some of the functions described above. In addition, the sound wave reverberation apparatus provided in the foregoing embodiment belongs to the same idea as the sound wave reverberation method embodiment. For details of the specific implementation process thereof, reference is made to the method embodiment. Details are not described herein again.

An embodiment of this disclosure further provides a computer device, the computer device including a processor and a memory, the memory having at least one computer program stored therein, the at least one computer program being loaded and executed by the processor to implement the operations performed in the sound wave reverberation method in the foregoing embodiment.

In some embodiments, the computer device is provided as a terminal. FIG. 14 is a structural block diagram of a terminal 1400 according to an embodiment of this disclosure. The terminal 1400 includes a processor 1401 and a memory 1402.

The processor 1401 may include one or more processing cores, for example, a 4-core processor or an 8-core processor. The processor 1401 may be implemented by using at least one of the following hardware forms: a digital signal processor (DSP), a field-programmable gate array (FPGA), and a programmable logic array (PLA). The processor 1401 may also include a main processor and a coprocessor. The main processor is a processor configured to process data in an awake state, and is also referred to as a central processing unit (CPU). The coprocessor is a low-power processor configured to process data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more computer-readable storage media. The computer-readable storage medium may be non-transient. The memory 1402 may further include a high-speed random-access memory (RAM) and a nonvolatile memory, for example, one or more disk storage devices or flash storage devices. In some embodiments, the non-transient computer-readable storage medium in the memory 1402 is configured to store at least one computer program. The at least one computer program is configured to be executed by the processor 1401 to implement the sound wave reverberation method provided in the method embodiments of this disclosure.

In some embodiments, the terminal 1400 may further include a peripheral device interface 1403 and at least one peripheral device. The processor 1401, the memory 1402, and the peripheral interface 1403 may be connected through a bus or a signal line. Each peripheral may be connected to the peripheral device interface 1403 through a bus, a signal line, or a circuit board. In some examples, the peripheral device includes at least one of a radio frequency (RF) circuit 1404, a display screen 1405, a camera assembly 1406, an audio circuit 1407, or a power supply 1408.

The peripheral device interface 1403 may be configured to connect the at least one peripheral device related to input/output (I/O) to the processor 1401 and the memory 1402. In some embodiments, the processor 1401, the memory 1402, and the peripheral device interface 1403 are integrated on the same chip or circuit board. In some other embodiments, any one or two of the processor 1401, the memory 1402, and the peripheral device interface 1403 may be implemented on an independent chip or circuit board, which is not limited in this embodiment.

The RF circuit 1404 is configured to receive and transmit an RF signal, which is also referred to as an electromagnetic signal. The RF circuit 1404 communicates with a communication network and another communication device through the electromagnetic signal. The RF circuit 1404 converts an electrical signal into an electromagnetic signal for transmission, or converts a received electromagnetic signal into an electrical signal. In some embodiments, the RF circuit 1404 includes an antenna system, an RF transceiver, one or more amplifiers, a tuner, an oscillator, a DSP, a codec chipset, a user identity module card, and the like. The RF circuit 1404 may communicate with another terminal through at least one wireless communication protocol. The wireless communication protocol includes, but is not limited to, a World Wide Web, a metropolitan area network, an intranet, generations of mobile communication networks (2G, 3G, 4G, and 5G), a wireless local area network, and/or a Wi-Fi network. In some embodiments, the RF circuit 1404 may further include a circuit related to near field communication (NFC), which is not limited in this disclosure.

The display screen 1405 is configured to display a user interface (UI). The UI may include a graph, texts, an icon, a video, and any combination thereof. When the display screen 1405 is a touch display screen, the display screen 1405 further has a capability of acquiring a touch signal on or above a surface of the display screen 1405. The touch signal may be inputted into the processor 1401 as a control signal for processing. In this case, the display screen 1405 may be further configured to provide a virtual button and/or a virtual keyboard, which are/is also referred to as a soft button and/or a soft keyboard. In some embodiments, one display screen 1405 may be arranged on a front panel of the terminal 1400. In some other embodiments, at least two display screens 1405 may be respectively arranged on different surfaces of the terminal 1400 or may be folded. In some other embodiments, the display screen 1405 may be a flexible display screen arranged on a curved surface or a folded surface of the terminal 1400. Even, the display screen 1405 may be further set in a non-rectangular irregular pattern, namely, a special-shaped screen. The display screen 1405 may be manufactured through a material such as a liquid crystal display (LCD) or an organic light-emitting diode (OLED).

The camera assembly 1406 is configured to acquire an image or a video. In some embodiments, the camera assembly 1406 includes a front camera and a rear camera. The front camera is arranged on the front panel of the terminal, and the rear camera is arranged on a back of the terminal. In some embodiments, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and virtual reality (VR) photographing through fusion of the main camera and the wide-angle camera, or another fusion photographing function. In some embodiments, the camera assembly 1406 may further include a flash. The flash may be a single-color-temperature flash, or may be a dual-color-temperature flash. The dual-color-temperature flash is a combination of a warm flash and a cold flash, which may be configured for light compensation at different color temperatures.

The audio circuit 1407 may include a microphone and a speaker. The microphone is configured to acquire sound waves of a user and an environment, and convert the sound wave into an electrical signal to be inputted to the processor 1401 for processing, or inputted to the RF circuit 1404 for implementing voice communication. For the purpose of stereo acquisition or noise reduction, a plurality of microphones may be respectively arranged at different parts of the terminal 1400. The microphone may be further an array microphone or an omni-directional acquisition microphone. The speaker is configured to convert the electrical signals from the processor 1401 or the RF circuit 1404 into sound waves. The speaker may be a related film speaker, or may be a piezoelectric ceramic speaker. When the speaker is the piezoelectric ceramic speaker, the speaker not only may convert an electric signal into the sound wave audible to human, but also may convert the electric signal into the sound wave inaudible to the human for purposes such as ranging. In some embodiments, the audio circuit 1407 may further include an earphone jack.

The power supply 1408 is configured to supply power to components in the terminal 1400. The power supply 1408 may be an alternating current, a direct current, a disposable battery, or a rechargeable battery. When the power supply 1408 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery is further configured to support a fast charging technology.

The structure shown in FIG. 14 does not constitute a limitation on the terminal 1400. The terminal may include more or fewer components than those shown in the figure, or some merged components, or different component arrangements.

In some embodiments, the computer device is provided as a server. FIG. 15 is a schematic structural diagram of a server according to an embodiment of this disclosure. A server 1500 may vary considerably in configuration or performance, and may include one or more CPUs 1501 and one or more memories 1502. The memory 1502 has at least one computer program stored therein, the at least one computer program being loaded and executed by the processor 1501 to implement the method provided in the foregoing method embodiments. The server may further have components such as a wired or wireless network interface, a keyboard, and an I/O interface, to perform input and output. The server may further include another component configured to implement a device function. Details are not described herein.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

An embodiment of this disclosure further provides a computer-readable storage medium (e.g., a non-transitory computer-readable storage medium), having at least one computer program stored therein, the at least one computer program being loaded and executed by processing circuitry (e.g., a processor) to implement the operations performed in the sound wave reverberation method in one or more foregoing embodiments.

An embodiment of this disclosure further provides a computer program product, including a computer program, the computer program, when executed by processing circuitry (e.g., a processor), implementing the operations performed in the sound wave reverberation method in one or more foregoing embodiments.

All or part of the operations of implementing one or more foregoing embodiments may be implemented by hardware, or may be implemented by a program instructing related hardware. The program may be stored in a computer-readable storage medium (e.g., a non-transitory computer-readable storage medium). The foregoing storage medium may be a read-only memory, a magnetic disk, an optical disc, or the like.

The foregoing descriptions include non-limiting examples of this disclosure, and are not intended to limit the scope of this disclosure. Any modification, replacement, improvement, or the like made within the spirit and principle of one or more embodiments of this disclosure shall fall within the scope of this disclosure.

What is claimed is:

1. A sound wave reverberation method, the method comprising:
obtaining attenuation parameters of a plurality of image sound sources corresponding to a sound source and delay durations of the image sound sources, the image sound sources being configured to simulate a sound wave that is emitted by the sound source and reaches a receiver after being reflected, the attenuation parameters indicating intensities of sound waves from the image sound sources and received by the receiver, and the delay durations being durations of travel of the sound waves from the image sound sources to the receiver;
determining an impulse response of each of the image sound sources based on an impulse function and the delay duration of the respective image sound source;
for each of the image sound sources, performing convolution on a first sound wave, the attenuation parameter of the respective image sound source, and the impulse response of the respective image sound source to obtain a second sound wave corresponding to the respective image sound source, the first sound wave being a sound wave emitted by the sound source and received by the receiver, and the second sound wave corresponding to the respective image sound source being a sound wave emitted by the respective image sound source and received by the receiver; and
generating a target sound wave based on superposition of the obtained second sound waves.

2. The method according to claim 1, wherein the obtaining the attenuation parameters comprises:
for a current image sound source of the image sound sources,
obtaining an absorption rate corresponding to the current image sound source; and
determining the attenuation parameter of the current image sound source based on a first distance and the absorption rate, the first distance being a distance between the receiver and the current image sound source.

3. The method according to claim 2, wherein the determining the attenuation parameter of the current image sound source comprises:
determining a ratio of the absorption rate to the first distance as the attenuation parameter of the current image sound source; or
determining a product of the first distance and a target value, and determining a ratio of the absorption rate to the product as the attenuation parameter of the current image sound source.

4. The method according to claim 1, wherein the obtaining the delay durations comprises:
for a current image sound source of the image sound sources,
determining a ratio of a first distance to a sound wave transmission speed as the delay duration of the current image sound source, the first distance being a distance between the receiver and the current image sound source.

5. The method according to claim 1, wherein the determining the impulse response of each of the image sound sources comprises:
for a current image sound source of the image sound sources,
applying a target duration and the delay duration of the current image sound source to the impulse function to obtain the impulse response of the current image sound source, the target duration being a duration of travel of the sound wave emitted by the sound source to the receiver without reflection.

6. The method according to claim 1, wherein the performing convolution comprises:
for a current image sound source of the image sound sources,
determining a product of the first sound wave and the attenuation parameter of the current image sound source; and
performing convolution on the product and the impulse response of the current image sound source to obtain the second sound wave corresponding to the current image sound source.

7. The method according to claim 1, wherein the generating the target sound wave comprises:
superposing the first sound wave and the second sound waves to obtain the target sound wave.

8. The method according to claim 1, wherein
the obtaining the attenuation parameters and the delay durations comprises:
for a current image sound source of the image sound sources,
obtaining the attenuation parameters of the current image sound source at a plurality of first sampling moments; and
obtaining the delay durations of the current image sound source at the first sampling moments;
the performing convolution comprises:
for the current image sound source of the image sound sources,
performing convolution on the first sound wave, the attenuation parameter of the current image sound source at each of the first sampling moments, and the impulse response of the current image sound source at the respective first sampling moment to obtain a second sound wave of the current image sound source at the respective first sampling moment, the impulse response of the current image sound source at the respective first sampling moment being determined based on the impulse function and the delay duration of the current image sound source at the respective first sampling moment; and
the generating the target sound wave comprises:
superposing components of the second sound waves of the image sound sources at a same first sampling moment to obtain a superposed component of the target sound wave at the same first sampling moment.

9. The method according to claim 1, wherein
the image sound sources include a first image sound source and a second image sound source, a distance between the first image sound source and the sound source being a second distance, a distance between the second image sound source and the sound source being a third distance, and the second distance being less than the third distance; and
the obtaining the attenuation parameters and the delay durations comprises:
obtaining attenuation parameters of the first image sound source at a plurality of first sampling moments based on a first sampling rate;
obtaining attenuation parameters of the second image sound source at a plurality of second sampling moments based on a second sampling rate, the first sampling rate being higher than the second sampling rate;
obtaining delay durations of each of the image sound sources at the second sampling moments based on the second sampling rate;
performing upsampling on the attenuation parameters of the second image sound source at the second sampling moments to obtain attenuation parameters of the second image sound source at the first sampling moments; and
performing upsampling on the delay durations of each of the image sound sources at the second sampling moments to obtain delay durations of each of the image sound sources at the first sampling moments.

10. The method according to claim 9, wherein the obtaining the attenuation parameters of the first image sound source at the first sampling moments comprises:
obtaining positions of the sound source at the first sampling moments from a motion trajectory of the sound source based on the first sampling rate;
determining a position of the first image sound source at each of the first sampling moments based on the position of the sound source at the respective first sampling moment; and
obtaining the attenuation parameter of the first image sound source at each of the first sampling moments based on the position of the first image sound source at the respective first sampling moment and a position of the receiver.

11. The method according to claim 9, wherein the obtaining the delay durations of each of the image sound sources at the second sampling moments comprises:
obtaining positions of the sound source at the second sampling moments from a motion trajectory of the sound source based on the second sampling rate;
determining a position of each of the image sound sources at each of the second sampling moments based on the position of the sound source at the respective second sampling moment; and
obtaining, for each of the image sound sources, the delay duration of the respective image sound source at each of the second sampling moments based on the position of the respective image sound source at the respective second sampling moment and a position of the receiver.

12. A sound wave reverberation apparatus, comprising:
processing circuitry configured to:
obtain attenuation parameters of a plurality of image sound sources corresponding to a sound source and delay durations of the image sound sources, the image sound sources being configured to simulate a sound wave that is emitted by the sound source and reaches a receiver after being reflected, the attenuation parameters indicating intensities of sound waves from the image sound sources and received by the receiver, and the delay durations being durations of travel of the sound waves from the image sound sources to the receiver;
determine an impulse response of each of the image sound sources based on an impulse function and the delay duration of the respective image sound source;
for each of the image sound sources, perform convolution on a first sound wave, the attenuation parameter of the respective image sound source, and the impulse response of the respective image sound source to obtain a second sound wave corresponding to the respective image sound source, the first sound wave being a sound wave emitted by the sound source and received by the receiver, and the second sound wave corresponding to the respective image sound source being a sound wave emitted by the respective image sound source and received by the receiver; and
generate a target sound wave based on superposition of the obtained second sound waves.

13. The apparatus according to claim 12, wherein the processing circuitry is configured to:
for a current image sound source of the image sound sources,
obtain an absorption rate corresponding to the current image sound source; and
determine the attenuation parameter of the current image sound source based on a first distance and the absorption rate, the first distance being a distance between the receiver and the current image sound source.

14. The apparatus according to claim 12, wherein the processing circuitry is configured to:
for a current image sound source of the image sound sources,
determine a ratio of a first distance to a sound wave transmission speed as the delay duration of the current image sound source, the first distance being a distance between the receiver and the current image sound source.

15. The apparatus according to claim 12, wherein the processing circuitry is configured to:
for a current image sound source of the image sound sources,
apply a target duration and the delay duration of the current image sound source to the impulse function to obtain the impulse response of the current image sound source, the target duration being a duration of travel of the sound wave emitted by the sound source to the receiver without reflection.

16. The apparatus according to claim 12, wherein the processing circuitry is configured to:
for a current image sound source of the image sound sources:
obtain the attenuation parameters of the current image sound source at a plurality of first sampling moments;
obtain the delay durations of the current image sound source at the first sampling moments; and
perform convolution on the first sound wave, the attenuation parameter of the current image sound source at each of the first sampling moments, and the impulse response of the current image sound source at the respective first sampling moment to obtain a second sound wave of the current image sound source at the respective first sampling moment, the impulse response of the current image sound source at the respective first sampling moment being determined based on the impulse function and the delay duration of the current image sound source at the respective first sampling moment; and
superpose components of the second sound waves of the image sound sources at a same first sampling moment to obtain a superposed component of the target sound wave at the same first sampling moment.

17. The apparatus according to claim 12, wherein
the image sound sources include a first image sound source and a second image sound source, a distance between the first image sound source and the sound source being a second distance, a distance between the second image sound source and the sound source being a third distance, and the second distance being less than the third distance; and
the processing circuitry is configured to:
obtain attenuation parameters of the first image sound source at a plurality of first sampling moments based on a first sampling rate;
obtain attenuation parameters of the second image sound source at a plurality of second sampling moments based on a second sampling rate, the first sampling rate being higher than the second sampling rate;
obtain delay durations of each of the image sound sources at the second sampling moments based on the second sampling rate;
perform upsampling on the attenuation parameters of the second image sound source at the second sampling moments to obtain attenuation parameters of the second image sound source at the first sampling moments; and
perform upsampling on the delay durations of each of the image sound sources at the second sampling moments to obtain delay durations of each of the image sound sources at the first sampling moments.

18. The apparatus according to claim 17, wherein the processing circuitry is configured to:
obtain positions of the sound source at the first sampling moments from a motion trajectory of the sound source based on the first sampling rate;
determine a position of the first image sound source at each of the first sampling moments based on the position of the sound source at the respective first sampling moment; and
obtain the attenuation parameter of the first image sound source at each of the first sampling moments based on the position of the first image sound source at the respective first sampling moment and a position of the receiver.

19. The apparatus according to claim 17, wherein the processing circuitry is configured to:
obtain positions of the sound source at the second sampling moments from a motion trajectory of the sound source based on the second sampling rate;
determine a position of each of the image sound sources at each of the second sampling moments based on the position of the sound source at the respective second sampling moment; and
obtain, for each of the image sound sources, the delay duration of the respective image sound source at each of the second sampling moments based on the position of the respective image sound source at the respective second sampling moment and a position of the receiver.

20. A non-transitory computer-readable storage medium storing instructions, which when executed by a processor, cause the processor to perform a sound wave reverberation method, the method comprising:
obtaining attenuation parameters of a plurality of image sound sources corresponding to a sound source and delay durations of the image sound sources, the image sound sources being configured to simulate a sound wave that is emitted by the sound source and reaches a receiver after being reflected, the attenuation parameters indicating intensities of sound waves from the image sound sources and received by the receiver, and the delay durations being durations of travel of the sound waves from the image sound sources to the receiver;
determining an impulse response of each of the image sound sources based on an impulse function and the delay duration of the respective image sound source;
for each of the image sound sources, performing convolution on a first sound wave, the attenuation parameter of the respective image sound source, and the impulse response of the respective image sound source to obtain a second sound wave corresponding to the respective image sound source, the first sound wave being a sound wave emitted by the sound source and received by the receiver, and the second sound wave corresponding to the respective image sound source being a sound wave emitted by the respective image sound source and received by the receiver; and
generating a target sound wave based on superposition of the obtained second sound waves.
